(19) United States
(12) Patent Application Publication
(10) Pub. No.: US 2026/0230132 A1
(43) Pub. Date: Aug. 6, 2026

(54) PRE-SOUNDING FRAMES IN COORDINATED BEAMFORMING SOUNDING PROCEDURES

(71) Applicant: QUALCOMM Incorporated, San Diego, CA (US)

(72) Inventors: Sameer VERMANI, San Diego, CA (US); Sherief HELWA, San Diego, CA (US); Ahmed Ragab ELSHERIF, San Jose, CA (US); Bin TIAN, San Diego, CA (US); Youhan KIM, Saratoga, CA (US); George CHERIAN, San Diego, CA (US); Alfred ASTERJADHI, San Diego, CA (US)

(21) Appl. No.: 19/462,622

(22) Filed: Jan. 28, 2026

Related U.S. Application Data
(60) Provisional application No. 63/753,773, filed on Feb. 4, 2025.

(51) Int. Cl. H04B 7/06

(52) U.S. Cl. CPC H04B 7/0617

(57) ABSTRACT

This disclosure provides methods, components, devices and systems for pre-sounding frame exchange for coordinated beamforming (CoBF) sounding procedures. Some examples more specifically relate to coordination between a first wireless access point (AP) and a second wireless AP prior to performance of a CoBF sounding procedure. For example, the first wireless AP may transmit, to the second wireless AP, a first frame that includes an invitation for the second wireless AP to perform a CoBF sounding procedure with the first wireless AP. In accordance with receiving the first frame, the second wireless AP may transmit a second frame that indicates whether the second wireless AP accepts the invitation to perform the CoBF sounding procedure. If the second wireless AP accepts the invitation, the first wireless AP and the second wireless AP may perform the CoBF sounding procedure.

### CROSS REFERENCES

This Patent Application claims the benefit of U.S. Provisional Patent Application No. 63/753,773 by VERMANI et al., entitled “PRE-SOUNDING FRAMES IN COORDINATED BEAMFORMING SOUNDING PROCEDURES,” filed Feb. 4, 2025, assigned to the assignee hereof, and expressly incorporated herein.

### TECHNICAL FIELD

This disclosure relates generally to wireless communication and, more specifically, to pre-sounding frames in coordinated beamforming (CoBF) sounding procedures.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

Some wireless communication networks may implement coordinated beamforming (CoBF) sounding procedures to facilitate beamforming between a wireless AP and a wireless STA. In some cases, a first wireless AP and a second wireless AP may perform a joint sounding procedure, in which the first wireless AP and the second wireless AP may sound respective packets (for example, null data packets (NDPs) such as packets that contain a preamble but no payload) simultaneously to a first wireless STA that is associated with the first wireless AP. The first wireless STA may obtain joint channel state information (CSI) associated with a first channel between the first wireless AP and the first wireless STA and with a second channel between the second wireless AP and the first wireless STA and may indicate the joint CSI to the first wireless AP. The first wireless AP and/or the second wireless AP may utilize the joint CSI for beamforming with the first wireless STA. The first wireless AP and the second wireless AP may proceed to perform a similar procedure for a second wireless STA that is associated with the second wireless AP, such that the second wireless AP and/or the first wireless AP may utilize the joint CSI from the second wireless STA for beamforming with the second wireless STA.

In some other cases, the first wireless AP and the second wireless AP may perform a sequential sounding procedure. In such cases, the first wireless AP may sound a first packet to the first wireless STA. The first wireless STA may obtain first CSI of a first channel between the first wireless AP and the first wireless STA using the first packet and indicate the first CSI to the first wireless AP. Subsequently, the second wireless AP may sound a second packet to the first wireless STA and the first wireless STA may obtain second CSI of a second channel between the second wireless AP and the first wireless STA using the second packet. The second wireless AP may obtain the second CSI. The first wireless AP and the second wireless AP may utilize the first CSI and the second CSI, respectively, for beamforming with the first wireless STA. The first wireless AP and the second wireless AP may proceed to perform a similar procedure with the second wireless STA, such that the second wireless AP and/or the first wireless AP may utilize the CSI(s) from the second wireless STA for beamforming with the second wireless STA.

In such cases, however, the first wireless AP and the second wireless AP may not coordinate various aspects of the CoBF sounding procedures, including failing to coordinate before performance of the CoBF sounding procedures, which may lead to inefficiencies and/or inaccuracies during the CoBF sounding procedures.

### SUMMARY

The systems, methods, and devices of this disclosure each have several innovative examples, no single one of which is solely responsible for the desirable attributes disclosed herein.

One innovative aspect of the subject matter described in this disclosure can be implemented in a method for wireless communication by a first wireless access point (AP). The method may include transmitting, to a second wireless AP at a start of a first transmission opportunity, a first frame that includes an invitation for the second wireless AP to perform a coordinated beamforming (CoBF) sounding procedure with the first wireless AP and includes first information associated with the CoBF sounding procedure, one or more first wireless stations (STAs) being associated with the first wireless AP participating in the CoBF sounding procedure, receiving, from the second wireless AP and in accordance with the first frame including the invitation, a second frame that indicates whether the second wireless AP accepts the invitation to perform the CoBF sounding procedure with the first wireless AP, the second frame including second information associated with the CoBF sounding procedure, and performing, in accordance with the second wireless AP accepting the invitation, at least a first portion of the CoBF sounding procedure with the second wireless AP in the first transmission opportunity, the CoBF sounding procedure being performed in accordance with the first information and the second information.

Another innovative aspect of the subject matter described in this disclosure can be implemented in a first wireless AP for wireless communication. The first wireless AP may include a processing system that includes processor circuitry and memory circuitry that stores code. The processing system may be configured to cause the first wireless AP to transmit, to a second wireless AP at a start of a first transmission opportunity, a first frame that includes an invitation for the second wireless AP to perform a CoBF sounding procedure with the first wireless AP and includes first information associated with the CoBF sounding procedure, one or more first wireless STAs being associated with the first wireless AP participating in the CoBF sounding procedure, receive, from the second wireless AP and in accordance with the first frame including the invitation, a second frame that indicates whether the second wireless AP accepts the invitation to perform the CoBF sounding procedure with the first wireless AP, the second frame including second information associated with the CoBF sounding procedure, and perform, in accordance with the second wireless AP accepting the invitation, at least a first portion of the CoBF sounding procedure with the second wireless AP in the first transmission opportunity, the CoBF sounding procedure being performed in accordance with the first information and the second information.

Another innovative aspect of the subject matter described in this disclosure can be implemented in another first wireless AP for wireless communication. The first wireless AP may include means for transmitting, to a second wireless AP at a start of a first transmission opportunity, a first frame that includes an invitation for the second wireless AP to perform a CoBF sounding procedure with the first wireless AP and includes first information associated with the CoBF sounding procedure, one or more first wireless STAs being associated with the first wireless AP participating in the CoBF sounding procedure, means for receiving, from the second wireless AP and in accordance with the first frame including the invitation, a second frame that indicates whether the second wireless AP accepts the invitation to perform the CoBF sounding procedure with the first wireless AP, the second frame including second information associated with the CoBF sounding procedure, and means for performing, in accordance with the second wireless AP accepting the invitation, at least a first portion of the CoBF sounding procedure with the second wireless AP in the first transmission opportunity, the CoBF sounding procedure being performed in accordance with the first information and the second information.

Another innovative aspect of the subject matter described in this disclosure can be implemented in a non-transitory computer-readable medium storing code for wireless communication. The code may include instructions executable by one or more processors to transmit, to a second wireless AP at a start of a first transmission opportunity, a first frame that includes an invitation for the second wireless AP to perform a CoBF sounding procedure with the first wireless AP and includes first information associated with the CoBF sounding procedure, one or more first wireless STAs being associated with the first wireless AP participating in the CoBF sounding procedure, receive, from the second wireless AP and in accordance with the first frame including the invitation, a second frame that indicates whether the second wireless AP accepts the invitation to perform the CoBF sounding procedure with the first wireless AP, the second frame including second information associated with the CoBF sounding procedure, and perform, in accordance with the second wireless AP accepting the invitation, at least a first portion of the CoBF sounding procedure with the second wireless AP in the first transmission opportunity, the CoBF sounding procedure being performed in accordance with the first information and the second information.

In some examples of the method, first wireless APs, and non-transitory computer-readable medium described herein, the first information indicates a first quantity of spatial streams supported for reception of sounding packets by the one or more first wireless STAs, the second information indicates a second quantity of spatial streams supported for reception of the sounding packets by one or more second wireless STAs, and the CoBF sounding procedure may be performed in accordance with one of the first quantity of spatial streams or the second quantity of spatial streams.

In some examples of the method, first wireless APs, and non-transitory computer-readable medium described herein, the first information indicates a first quantity of long-training fields (LTFs) supported for reception of sounding packets by the one or more first wireless STAs, the second information indicates a second quantity of LTFs supported for reception of the sounding packets by one or more second wireless STAs, and the CoBF sounding procedure may be performed in accordance with one of the first quantity of LTFs or the second quantity of LTFs.

Another innovative aspect of the subject matter described in this disclosure can be implemented in a method for wireless communication by a first wireless AP. The method may include receiving, from a second wireless AP at a start of a first transmission opportunity, a first frame that includes an invitation for the first wireless AP to perform a CoBF sounding procedure with the second wireless AP and includes first information associated with the CoBF sounding procedure, one or more first wireless STAs being associated with the first wireless AP participating in the CoBF sounding procedure, transmitting, to the second wireless AP and in accordance with the first frame including the invitation, a second frame that indicates whether the first wireless AP accepts the invitation to perform the CoBF sounding procedure with the second wireless AP, the second frame including second information associated with the CoBF sounding procedure, and performing, in accordance with the first wireless AP accepting the invitation, at least a first portion of the CoBF sounding procedure with the second wireless AP in the first transmission opportunity, the CoBF sounding procedure being performed in accordance with the first information and the second information.

Another innovative aspect of the subject matter described in this disclosure can be implemented in a first wireless AP for wireless communication. The first wireless AP may include a processing system that includes processor circuitry and memory circuitry that stores code. The processing system may be configured to cause the first wireless AP to receive, from a second wireless AP at a start of a first transmission opportunity, a first frame that includes an invitation for the first wireless AP to perform a CoBF sounding procedure with the second wireless AP and includes first information associated with the CoBF sounding procedure, one or more first wireless STAs being associated with the first wireless AP participating in the CoBF sounding procedure, transmit, to the second wireless AP and in accordance with the first frame including the invitation, a second frame that indicates whether the first wireless AP accepts the invitation to perform the CoBF sounding procedure with the second wireless AP, the second frame including second information associated with the CoBF sounding procedure, and perform, in accordance with the first wireless AP accepting the invitation, at least a first portion of the CoBF sounding procedure with the second wireless AP in the first transmission opportunity, the CoBF sounding procedure being performed in accordance with the first information and the second information.

Another innovative aspect of the subject matter described in this disclosure can be implemented in another first wireless AP for wireless communication. The first wireless AP may include means for receiving, from a second wireless AP at a start of a first transmission opportunity, a first frame that includes an invitation for the first wireless AP to perform a CoBF sounding procedure with the second wireless AP and includes first information associated with the CoBF sounding procedure, one or more first wireless STAs being associated with the first wireless AP participating in the CoBF sounding procedure, means for transmitting, to the second wireless AP and in accordance with the first frame including the invitation, a second frame that indicates whether the first wireless AP accepts the invitation to perform the CoBF sounding procedure with the second wireless AP, the second frame including second information associated with the CoBF sounding procedure, and means for performing, in accordance with the first wireless AP accepting the invitation, at least a first portion of the CoBF sounding procedure with the second wireless AP in the first transmission opportunity, the CoBF sounding procedure being performed in accordance with the first information and the second information.

Another innovative aspect of the subject matter described in this disclosure can be implemented in a non-transitory computer-readable medium storing code for wireless communication. The code may include instructions executable by one or more processors to receive, from a second wireless AP at a start of a first transmission opportunity, a first frame that includes an invitation for the first wireless AP to perform a CoBF sounding procedure with the second wireless AP and includes first information associated with the CoBF sounding procedure, one or more first wireless STAs being associated with the first wireless AP participating in the CoBF sounding procedure, transmit, to the second wireless AP and in accordance with the first frame including the invitation, a second frame that indicates whether the first wireless AP accepts the invitation to perform the CoBF sounding procedure with the second wireless AP, the second frame including second information associated with the CoBF sounding procedure, and perform, in accordance with the first wireless AP accepting the invitation, at least a first portion of the CoBF sounding procedure with the second wireless AP in the first transmission opportunity, the CoBF sounding procedure being performed in accordance with the first information and the second information.

Some examples of the method, first wireless APs, and non-transitory computer-readable medium described herein may further include operations, features, means, or instructions for receiving, from a third wireless AP at a start of a second transmission opportunity, a third frame that includes a second invitation for the first wireless AP to perform a second CoBF sounding procedure with the third wireless AP and declining the second invitation to perform the second CoBF sounding procedure with the third wireless AP.

Details of one or more implementations of the subject matter described in this disclosure are set forth in the accompanying drawings and the description below. Other features, examples, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a process flow that supports pre-sounding frames in coordinated beamforming (CoBF) sounding procedures.

FIG. 3 shows an example of a timing diagram that supports pre-sounding frames in CoBF sounding procedures.

FIG. 4 shows an example of a timing diagram that supports pre-sounding frames in CoBF sounding procedures.

FIG. 5 shows an example of a timing diagram that supports pre-sounding frames in CoBF sounding procedures.

FIG. 6 shows an example of a timing diagram that supports pre-sounding frames in CoBF sounding procedures.

FIG. 7A and FIG. 7B show examples of timing diagrams that support pre-sounding frames in CoBF sounding procedures.

FIG. 8 shows a block diagram of an example wireless communication device that supports pre-sounding frames in CoBF sounding procedures.

FIGS. 9 and 10 show flowcharts illustrating example processes performable by or at a first wireless access point (AP) that supports pre-sounding frames in CoBF sounding procedures.

Like reference numbers and designations in the various drawings indicate like elements.

### DETAILED DESCRIPTION

The following description is directed to some particular examples for the purposes of describing innovative examples of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Various examples relate generally to coordinated beamforming (CoBF) sounding procedures. Some examples more specifically relate to coordination between a first wireless access point (AP) and a second wireless AP prior to performance of the CoBF sounding procedure. For example, the first wireless AP may transmit, to the second wireless AP via a first transmission opportunity, for example, at a start of the first transmission opportunity, a first frame that includes an invitation for the second wireless AP to perform a CoBF sounding procedure with the first wireless AP. In accordance with receiving the first frame, the second wireless AP may transmit, to the first wireless AP, a second frame that indicates whether the second wireless AP accepts the invitation to perform the CoBF sounding procedure. If the second wireless AP accepts the invitation, the first wireless AP and the second wireless AP may perform a portion of the CoBF sounding procedure (or the entire CoBF sounding procedure) in the first transmission opportunity. In some examples, the first wireless AP and the second wireless AP may coordinate (for example, negotiate) various aspects of the CoBF procedure via the first frame and the second frame. For example, the first wireless AP and the second wireless AP may: identify a quantity of spatial streams for sounding packets via the first and second frames; identify a quantity of long-training fields (LTFs) in the sounding packets via the first and second frames; establish which wireless AP of the first wireless AP and the second wireless AP is to be a synchronization reference (for example, an entity that transmits, to a synchronization follower, one or more synchronization signals, such that the synchronization follower may adjust a timing, phase, and/or frequency of one or more sounding packets according to the one or more synchronization signals) via the first and second frames; and/or identify a quantity of transmission opportunities in which the CoBF sounding procedure is to be performed via the first and second frames, among other examples.

Particular examples of the subject matter described in this disclosure can be implemented to realize one or more of the following potential advantages. In some implementations, by communicating the first frame and the second frame, the described techniques can be used to increase coordination between the first wireless AP and the second wireless AP prior to performance of the CoBF sounding procedure, which may increase the efficiency of the CoBF sounding procedure. In some implementations, by enabling the second wireless AP to accept or decline the invitation from the first wireless AP, the second wireless AP may experience a reduction in processing complexity and power consumption as part of CoBF sounding procedures, for example, due to declining an invitation in cases in which the second wireless AP agrees to perform additional CoBF sounding procedures with other wireless APs or in cases in which the second AP cannot perform the desired CoBF sounding procedure. Additionally, by providing an explicit indication of whether the second wireless AP accepts or declines the invitation, the first wireless AP may pivot to requesting a CoBF sounding procedure from another wireless AP, which may enable the first wireless AP to complete the CoBF sounding procedure.

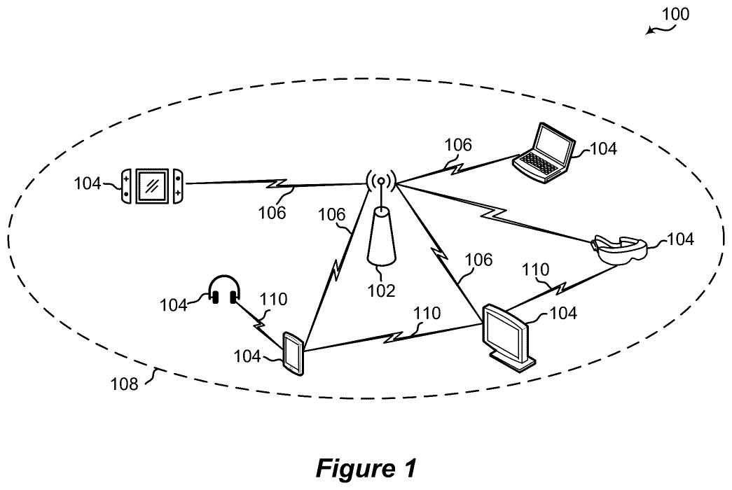

FIG. 1 shows a pictorial diagram of an example wireless communication network 100. According to some examples, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include CoBF and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

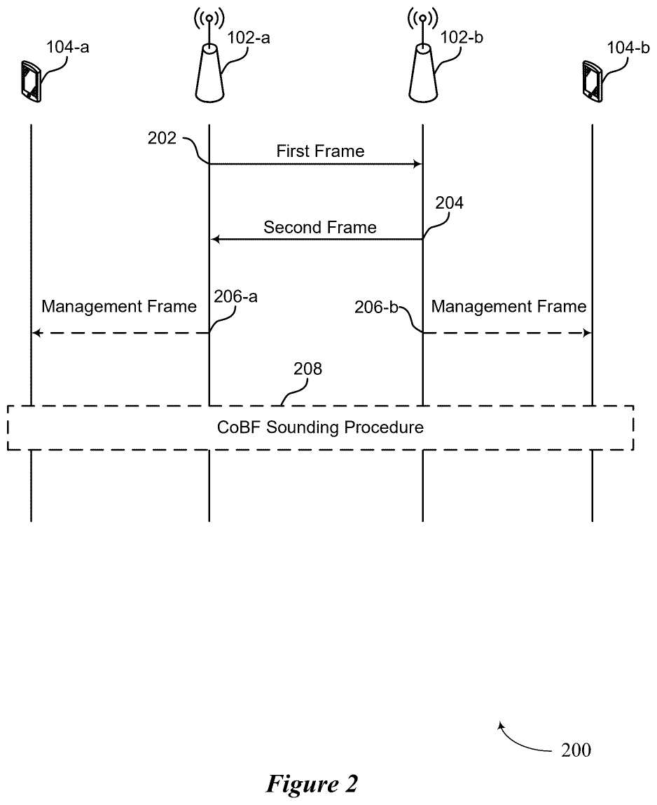

FIG. 2 shows an example of a process flow 200 that supports pre-sounding frames in CoBF sounding procedures. Aspects of the process flow 200 may implement, or be implemented by, examples of the wireless communication network 100. For example, the process flow 200 may be implemented by an AP 102-a and an AP 102-b, which may be examples of APs 102. Further, the process flow 200 may be implemented by a STA 104-a and a STA 104-b, which may be examples of STAs 104. In some examples, the STA 104-a may be associated with the AP 102-a and may be participating in a CoBF sounding procedure, while the STA 104-b may be associated with the AP 102-b and may be participating in the CoBF sounding procedure. That is, the STA 104-a may be part of a first BSS of the AP 102-a and the STA 104-b may be part of a second BSS of the AP 102-b. The APs 102 and the STAs 104 may be referred to as wireless APs 102 and wireless STAs 104.

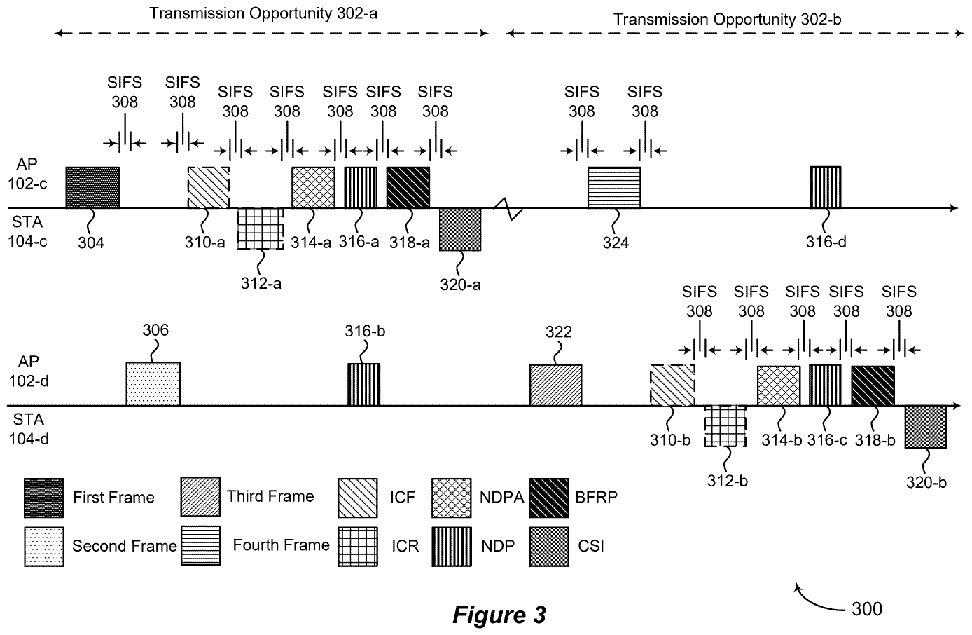

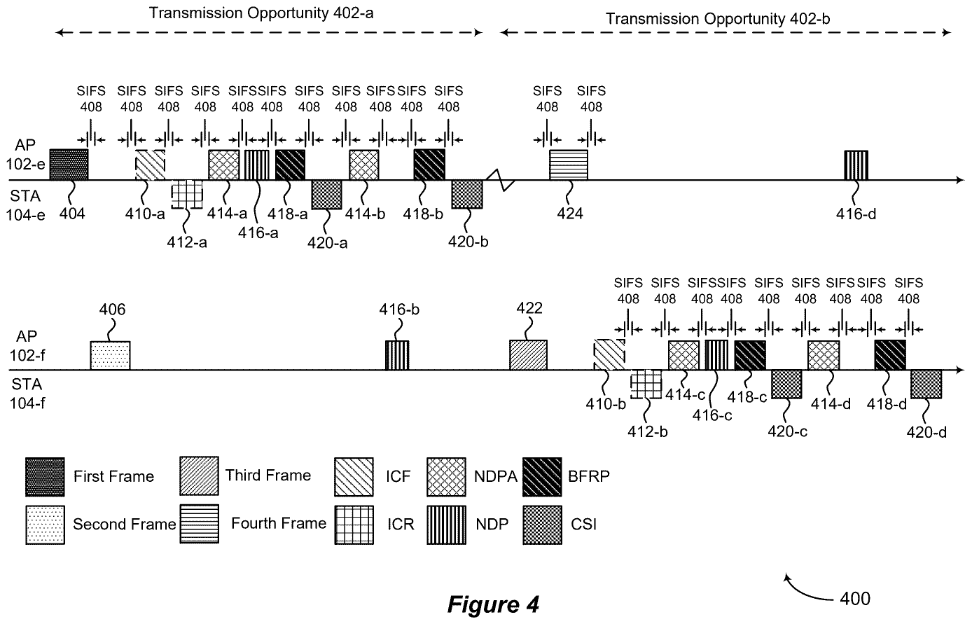

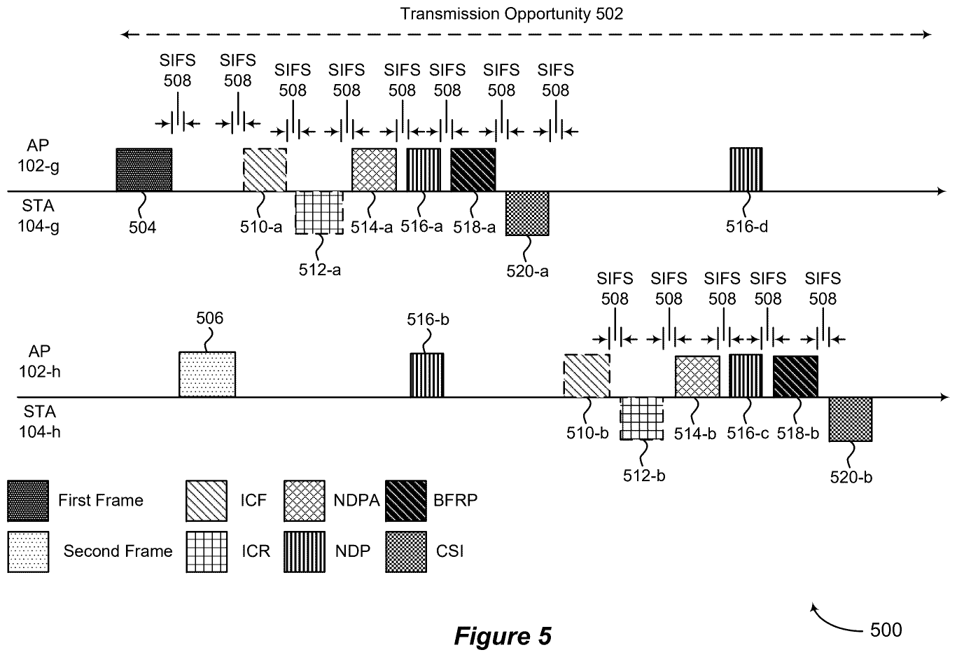

In some cases, the APs 102 may implement one of two CoBF sounding procedures. In one case, the APs 102 may implement a sequential CoBF sounding procedure, which may be further described herein with reference to FIGS. 4, 6, 7A, and 7B. In another case, the APs 102 may implement a joint CoBF sounding procedure, which may be further described herein with reference to FIGS. 3 and 5. In some other wireless communication networks, however, the APs 102 may not coordinate various aspects of the CoBF sounding procedure prior to performance of the CoBF sounding procedure, which may lead to inefficiencies and/or inaccuracies. The techniques described in the context of the process flow 200 enable the APs 102 to coordinate prior to performance of the CoBF sounding procedure.

At 202, the AP 102-a may transmit, to the AP 102-b, a first frame (for example, an invite frame) that includes an invitation for the AP 102-b to perform the CoBF sounding procedure with the AP 102-b. At 204, the AP 102-b may transmit, to the AP 102-a and in accordance with receiving the first frame, a second frame (for example, a response frame) that indicates whether the AP 102-b accepts the invitation. Such an exchange of frames may enable the AP 102-a to invite the AP 102-b for the CoBF sounding procedure and may enable the AP 102-b to either accept the invitation or indicate an unavailability (for example, decline the invitation) for various reasons.

In some examples, the AP 102-b may decline the invitation due to the AP 102-b being in active agreements to perform CoBF sounding procedures with other APs 102. As an illustrative example, the AP 102-b may have accepted invitations from the other APs 102 prior to reception of the first frame at 202. In such examples, the AP 102-b may determine that agreeing to another invitation from the AP 102-a may increase computational complexity and power consumption at the AP 102-b, leading the AP 102-b to decline the invitation via the second frame. In another example, the AP 102-b may decline the invitation from the AP 102-a in response to accepting invitations from other APs 102 and having reached a threshold (e.g., maximum) quantity of coordinated beamforming agreements supported by the AP 102-b.

In some other examples, the AP 102-b may decline the invite due to traffic between the STA 104-b and the AP 102-b being insufficient for the CoBF sounding procedure. For example, the AP 102-b and the STA 104-b may communicate a first quantity of traffic, which may fail to satisfy a threshold quantity of traffic sufficient for the CoBF sounding procedure. In such examples, the AP 102-b may decline the invitation from the AP 102-a.

The AP 102-b may decline the invitation from the AP 102-a according to an absence of any CoBF suitable STAs 104 associated with the AP 102-b. That is, the AP 102-b may decline the invitation from the AP 102-a according to the STA 104-b not being a candidate for the CoBF sounding procedure. For example, the AP 102-b may determine that the STA 104-b is not a candidate for the CoBF sounding procedure according to the location of the STA 104-b in relation to the locations of the AP 102-b and the AP 102-a. The AP 102-b may decline the invitation from the AP 102-a via the second frame.

In some examples, the AP 102-b may decline the invitation from the AP 102-a according to the STA 104-b having one or more operation modes enabled that are incompatible with the CoBF sounding procedure. In some other examples, the AP 102-b may decline the invitation from the AP 102-a in response to the AP 102-a repetitively failing to successfully receive cross-BSS CSI from the STA 104-b. For example, the AP 102-a may fail to receive a quantity of CSI from the STA 104-b. The AP 102-b may determine to decline the invitation from the AP 102-a in response to the quantity of CSI that were unsuccessfully received at the AP 102-a satisfying a threshold quantity of CSI.

If the AP 102-b declines the invitation, the AP 102-b may further indicate the reason for declining the invitation via the second frame. For example, the second frame may include an indication that the AP 102-b declines the invitation from the AP 102-b and further include an indication of the reason the AP 102-b declines the invitation. The reason may include an indication that the AP 102-b is in agreement with one or more other APs 102 for coordinated beamforming, an indication that traffic between the STA 104-b and the AP 102-b is insufficient for the CoBF sounding procedure, or an indication that the STA 104-b is not a candidate for the CoBF sounding procedure.

In some examples, the AP 102-b may decline the invitation by refraining from transmitting the second frame at 204. For example, the AP 102-b may signal the unavailability to perform the CoBF sounding procedure due to an engagement with another wireless device (for example, due to transmission and/or reception engagement with another STA 104 or AP 102), due to hidden transmissions to the AP 102-a (for example, the initiator AP 102), or both. In such examples, the AP 102-b may refrain from transmitting the second frame at 204. The AP 102-a may interpret an absence of the second frame as the AP 102-b declining (for example, rejecting) the invitation.

If the AP 102-a fails to receive the second frame at 204, the AP 102-a may re-transmit the first frame (for example, transmit a third frame) that includes a second invitation for the AP 102-b to perform a second CoBF procedure with the AP 102-a. In such examples, the AP 102-a may re-transmit the first frame after a duration. The duration is a predefined (for example, preconfigured value), is negotiated between the AP 102-a and the AP 102-b, or is selected from multiple predefined durations (for example, from multiple preconfigured values), among other examples.

By declining the invitation, the APs 102 may refrain from performing the operations at 206 and 208. That is, by declining the invitation, the APs 102 may refrain from performing the CoBF sounding procedure at 208. If the AP 102-b declines the invitation from the AP 102-a, the AP 102-a may transmit the first frame to a third AP 102 and proceed to perform the operations of the process flow 200 with the third AP 102.

In some examples, the AP 102-a and the AP 102-b may coordinate (for example, negotiate) various aspects of the CoBF sounding procedure via the first frame and the second frame. For example, the AP 102-a may indicate, via the first frame, first information associated with the CoBF sounding procedure. Similarly, the AP 102-b may indicate, via the second frame, second information associated with the CoBF sounding procedure.

In some examples, the AP 102-a and the AP 102-b may exchange, via the first information and the second information, a number of spatial streams ((Nss) for reception of sounding packets supported by the STAs 104 being sounded in the two BSSs. That is, as part of a sequential CoBF sounding procedure, the APs 102 may sound respective NDPs (for example, sounding packets) for the in-BSS STA 104 and the OBSS STA 104. To reduce errors in the CoBF procedure, the APs 102 may utilize a same quantity of spatial streams (for example, a same quantity of antennas, a same Nss) for both NDPs. By exchanging such the capability of the STAs 104, the APs 102 may coordinate the quantity of spatial streams utilized to sound the NDPs, leading to a reduction of errors in the CoBF sounding procedure.

For example, multiple first STAs 104, including the STA 104-a, may be associated with the AP 102-a. In such examples, the AP 102-a may identify a first quantity of spatial streams supported by the multiple first STAs 104 for sounding the NDPs. The first quantity of spatial streams may be a threshold (for example, minimum) quantity of spatial streams supported by the multiple first STAs 104. The AP 102-a may indicate, via the first information of the first frame, the first quantity of spatial streams. Similarly, multiple second STAs 104, including the STA 104-b, may be associated with the AP 102-b. The AP 102-b may identify a second quantity of spatial streams supported by the multiple second STAs 104 for sounding the NDPs. The second quantity of spatial streams may be a threshold (for example, minimum) quantity of spatial streams supported by the multiple second STAs 104. The AP 102-b may indicate, via the second information of the second frame, the second quantity of spatial streams.

To identify the quantity of spatial streams to use for sounding the NDPs, the APs 102 may utilize a predefined rule (for example, a preconfigured rule) that is based on the first quantity of spatial streams and the second quantity of spatial streams. As an illustrative example, the predefined rule may be that the APs 102 utilize the minimum of the first quantity of spatial streams and the second quantity of spatial streams for sounding the NDPs. As another illustrative example, the predefined rule may be that the APs 102 utilize the maximum of the first and second quantities of spatial streams, the average of the first and second quantities of spatial streams, or the mean of the first and second quantity of spatial streams, among other examples. Additionally, or alternatively, the AP 102-a (for example, the initiating AP 102) may determine to use one of the first quantity of spatial streams or the second quantity of spatial streams and indicate the determined quantity of spatial streams to the AP 102-b via a third frame (not shown).

As an illustrative example, the STA 104-a (for example, that is participating in the CoBF procedure) may support four spatial streams for reception of the sounding packets and a second STA 104 associated with the AP 102-a that is participating in the CoBF sounding procedure may support six spatial streams for reception of the sounding packets. The STA 104-b (for example, that is participating in the CoBF procedure) may support six spatial streams for reception of the sounding packets and a fourth STA associated with the AP 102-b that is participating in the CoBF sounding procedure may support eight spatial streams for reception of the sounding packets. In such examples, the AP 102-a may determine that four spatial streams are the minimum quantity of spatial streams supported by the STAs 104 associated with the AP 102-a. The AP 102-a may proceed to indicate, via the first frame, that the STAs 104 associated with the AP 102-a support four spatial streams for reception of the sounding packets. Similarly, the AP 102-b may determine that six spatial streams are the minimum quantity of spatial streams supported by the STAs 104 associated with the AP 102-b. The AP 102-b may proceed to indicate, via the second frame, that the STAs 104 associated with the AP 102-b support six spatial streams for reception of the sounding packets. The APs 102 may determine to utilize four spatial streams for transmission of the sounding packets in accordance with the four spatial streams being the minimum of the indicated quantities of spatial streams (for example, four is less than six).

In some examples, the AP 102-a and the AP 102-b may exchange, via the first information and the second information, a quantity of LTFs supported by the STAs 104 for reception of NDPs. That is, the APs 102 may include one or more LTFs within the NDP (for example, sounding packet). As such, different STAs 104 associated with each AP 102 may have support different quantity of LTFs within a NDP. For example, multiple first STAs 104, including the STA 104-a, may be associated with the AP 102-a. In such examples, the AP 102-a may identify a first quantity of LTFs for a NDP that are supported by the multiple first STAs 104. The first quantity of LTFs may be a threshold (for example, minimum) quantity of LTFs supported by the multiple first STAs 104. The AP 102-a may indicate, via the first information, the first quantity of LTFs. Similarly, multiple second STAs 104, including the STA 104-b, may be associated with the AP 102-b. The AP 102-b may identify a second quantity of LTFs for a NDP that are supported by the multiple second STAs 104. The second quantity of LTFs may be a threshold (for example, minimum) quantity of LTFs supported by the multiple second STAs 104. The AP 102-b may indicate, via the second information, the second quantity of LTFs.

To identify the quantity of LTFs to use for sounding the NDPs, the APs 102 may utilize a predefined rule (for example, a preconfigured rule) that is based on the first quantity of LTFs and the second quantity of LTFs. As an illustrative example, the predefined rule may be that the APs 102 utilize the minimum of the first quantity of LTFs and the second quantity of LTFs for sounding the NDPs. As another illustrative example, the predefined rule may be that the APs 102 utilize the maximum of the first and second quantities of LTFs, the average of the first and second quantities of LTFs, or the mean of the first and second quantity of LTFs, among other examples. Additionally, or alternatively, the AP 102-a (for example, the initiating AP 102) may determine to use one of the first quantity of LTFs or the second quantity of LTFs and indicate the determined quantity of LTFs to the AP 102-b via a third frame (not shown).

As an illustrative example, the STA 104-a (for example, that is participating in the CoBF procedure) may support the inclusion of four LTFs in the sounding packets and a second STA 104 associated with the AP 102-a that is participating in the CoBF procedure may support the inclusion of two LTFs in the sounding packets. The STA 104-b (for example, that is participating in the CoBF procedure) may support the inclusion of one LTF in the sounding packets and a fourth STA associated with the AP 102-b that is participating in the CoBF procedure may support the inclusion of two LTFs in the sounding packets. In such examples, the AP 102-a may determine that two LTFs are the minimum quantity of LTFs supported by the STAs 104 associated with the AP 102-a. The AP 102-a may proceed to indicate, via the first frame, that the STAs 104 associated with the AP 102-a support the inclusion of two LTFs in the sounding packets. Similarly, the AP 102-b may determine that a single LTF is the minimum quantity of LTF supported by the STAs 104 associated with the AP 102-b. The AP 102-b may proceed to indicate, via the second frame, that the STAs 104 associated with the AP 102-b support the inclusion of a single LTF in the sounding packets. The APs 102 may determine to include a single LTF in the sounding packets in accordance with the single LTF being the minimum of the indicated quantities of LTFs (for example, one is less than two).

In some other examples, the AP 102-a and the AP 102-b may establish, via the first information and/or second information, which of the AP 102-a and the AP 102-b is a synchronization reference and a synchronization follower and whether one or more synchronization signals (for example, pre-transmission stage sounding synchronization frames) are pre-corrected by the synchronization reference (for example, the sharing AP). For example, prior to, or as part of, the CoBF sounding procedure, the synchronization reference may transmit the one or more synchronization signals to the synchronization follower. The synchronization follower may receive the one or more synchronization signals and adjust a timing, a phase, and/or frequency for the NDPs communicated during the CoBF sounding procedure according to the one or more synchronization signals. That is, the synchronization follower may synchronize the timing, phase, and/or frequency for communication of the NDP according to the one or more synchronization signals.

In such examples, the AP 102-a and the AP 102-b may identify the synchronization reference and the synchronization follower via the first information and/or the second information. In some examples, the AP 102-a (for example, the initiating AP 102-a) may be the synchronization reference according to transmitting the first frame at 202. That is, the AP 102-a may be implicitly established as the synchronization reference according to (for example, based on) being the initiator of the CoBF sounding procedure with the AP 102-b. In some other examples, the AP 102-a may indicate, via the first information, which of the AP 102-a and the AP 102-b is to be the synchronization reference.

In some examples, the AP 102-a and the AP 102-b may exchange capabilities associated with the joint and/or sequential CoBF sounding procedures via the first information and the second information. For example, the AP 102-a may indicate, via the first information, a capability to perform both the joint and the sequential CoBF sounding procedure, while the AP 102-b may indicate, via the second information a capability to perform the joint CoBF sounding procedure. The APs 102 may proceed to perform the joint CoBF sounding procedure according to the first information and the second information.

In some examples, the AP 102-a and the AP 102-b may indicate, via the first information and the second information, respectively, which of the joint CoBF sounding procedure or the sequential CoBF sounding procedure to perform. For example, the AP 102-a may indicate via the first information, to perform the joint CoBF sounding procedure. The APs 102 may perform the joint CoBF sounding procedure according to the first information. In some other examples, the AP 102-a may indicate, via the second information, to perform the sequential CoBF sounding procedure. The APs 102 may perform the sequential CoBF sounding procedure according to the second information. If both APs 102 indicate different CoBF sounding procedures, the APs 102 may perform the CoBF sounding procedure indicated by the AP 102-b. In other examples, if both APs 102 indicate different CoBF sounding procedure, the APs 102 may perform the CoBF sounding procedure indicated by the AP 102-a.

In some examples, the APs 102 may convey a suggested modulation and coding scheme (MCS) for collecting CSI feedback from OBSS STAs 104 (for example, using TB PPDUs). For example, the AP 102-a may indicate, to the AP 102-b via the first information, a first MCS that is to be used by the STA 104-b (the OBSS STA 104 for the AP 102-a) to transmit first CSI feedback calculated by the STA 104-b. In such examples, the AP 102-b may indicate (for example, via a management frame, a control frame, or a NDP announcement (NDPA) frame) to the STA 104-b to use the first MCS for transmission of the first CSI feedback. Similarly, the AP 102-b may indicate, to the AP 102-a via the second information, a second MCS that is to be used by the STA 104-a (the OBSS STA 104 for the AP 102-b) to transmit second CSI feedback calculated by the STA 104-a. The AP 102-a may indicate (for example, via a management frame, a control frame, or a NDPA frame) to the STA 104-a to use the second MCS for transmission of the second CSI feedback.

In some examples, the APs 102 may negotiate, via the first information and the second information, a quantity of transmission opportunities used for the CoBF sounding procedure. For example, the AP 102-a may indicate, via the first information, a first quantity of transmission opportunities to use for the CoBF sounding procedure. The APs 102 may perform the CoBF sounding procedure in the first quantity of transmission opportunities. Similarly, the AP 102-b may indicate, via the second information, a second quantity of transmission opportunities to use for the CoBF sounding procedure. The APs 102 may perform the CoBF sounding procedure in the second quantity of transmission opportunities.

In some examples, if the AP 102-a and the AP 102-b indicate different quantities of transmission opportunities, the APs 102 may perform the CoBF sounding procedure in a quantity of transmission opportunities that are indicated by the AP 102-b. In some other examples, if the AP 102-a and the AP 102-b indicate different quantities of transmission opportunities, the APs 102 may perform the CoBF sounding procedure in a quantity of transmission opportunities that are indicated by the AP 102-a.

In some examples, the APs 102 may determine whether to communicate initial control frames (ICFs) and initial control responses (ICRs) as part of the CoBF sounding procedure according to a mode in which the STAs 104-a and 104-b are operating and indicate the determination via the first information and the second information.

For example, if the STAs 104-a and 104-b are operating in a lower capability mode (for example, a first mode, such as an enhanced multi-link single radio (eMLSR) mode, a dynamic power saving (DPS) mode, a non-primary channel access (NPCA) mode, a dynamic sub-band operation (DSO) mode, or a dynamic unavailability operation (DUO) mode), the APs 102 may transmit the ICFs to indicate to the STAs 104 to operate according to full capabilities (for example, a normal operating mode). The STAs 104 may receive the ICF, transition into operating according to full capabilities (for example, a second mode, such as a full capability mode or a normal mode), and transmit the ICR indicating that the STAs 104 have transitioned.

In some examples, instead of transmitting the ICF and ICR frames as part of the CoBF sounding procedure, the APs 102-a and 102-b may determine to refrain from transmitting such ICF and ICR frames and indicate such a determination via the first information and the second information. In such examples (in accordance with determining to refrain from transmitting the ICF and ICR frames), the APs 102 may transmit a management frame to the associated STAs 104 that instructs (for example, indicates) for the STAs 104 to disable the lower capability mode (for example, a disablement request) prior to the CoBF sounding procedure. For example, if the STA 104-a is operating in the lower capability mode, the AP 102-a may optionally transmit, at 206-a, the management frame indicating to the STA 104-a to disable the lower capability mode and to operate according to the full capability mode. Similarly, at 206-b, if the STA 104-b is operating in the lower capability mode, the AP 102-b may optionally transmit the management frame indicating to the STA 104-b to disable the lower capability mode and to operate according to the full capability mode.

In some other examples, the AP 102-a and the AP 102-b may indicate such a disablement request via a first control frame that announces a start of the CoBF sounding procedure. For example, the AP 102-a may transmit, via a first control frame that announces the start of the CoBF sounding procedure for the STA 104-a, an indication to the STA 104-a to disable the lower capability mode and to operate according to the full capability mode. Similarly, the AP 102-b may transmit, via a first control frame that announces the start of the CoBF sounding procedure for the STA 104-b, an indication to the STA 104-b to disable the lower capability mode and to operate according to the full capability mode.

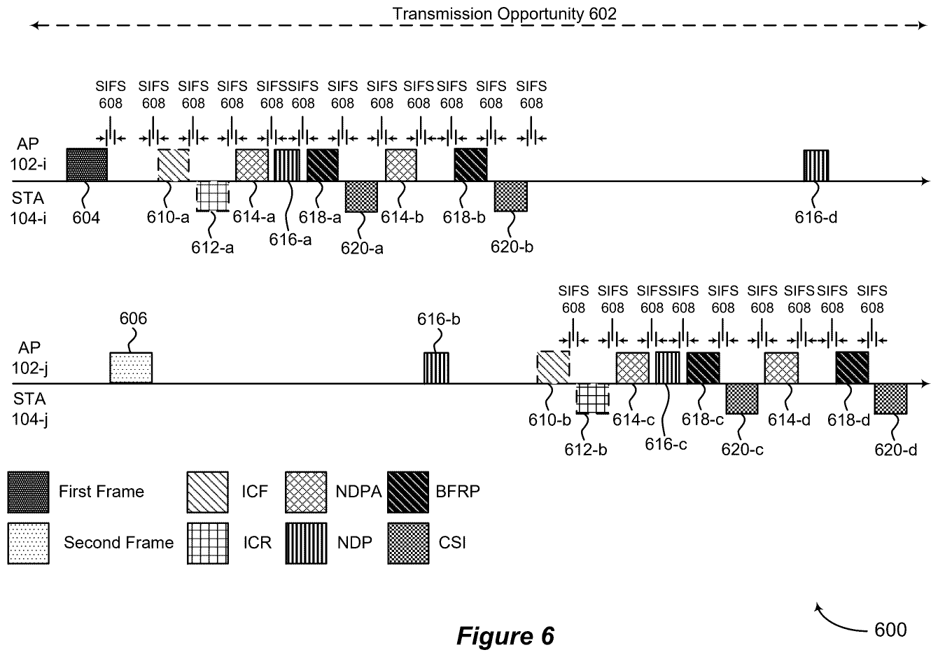

At 208, the AP 102-a, the AP 102-b, the STA 104-a, and the STA 104-b may perform the CoBF sounding procedure according to the first information and the second information exchanged via the first frame and the second frame. In some examples, the APs 102 and STAs 104 may perform the CoBF sounding procedure in two or more transmission opportunities, which may be further described herein with reference to FIGS. 2, 3, 7A, and 7B. In some other examples, the APs 102 and the STAs 104 may perform the CoBF sounding procedure in a single transmission opportunity, which may be further described herein with reference to FIGS. 5 and 6.

FIG. 3 shows an example of a timing diagram 300 that supports pre-sounding frames in CoBF sounding procedures. Aspects of the timing diagram 300 may implement, or be implemented by, examples of the wireless communication network 100 and the process flow 200. For example, the timing diagram 300 may be implemented by an AP 102-c and an AP 102-d, which may be examples of APs 102. Further, the timing diagram 300 may be implemented by a STA 104-c and a STA 104-d, which may be examples of STAs 104. In such examples, the STA 104-c may be associated with the AP 102-c and may be participating in a CoBF sounding procedure, while the STA 104-d may be associated with the AP 102-d and may be participating in the CoBF sounding procedure. That is, the STA 104-c may be part of a first BSS of the AP 102-c and the STA 104-d may be part of a second BSS of the AP 102-d. The APs 102 and the STAs 104 may be referred to as wireless APs 102 and wireless STAs 104. The timing diagram 300 may illustrate coordination between the APs 102 prior to the performance of a joint CoBF procedure in two transmission opportunities 302.

For example, the AP 102-c may transmit, via a transmission opportunity 302-a, for example, at a start of the transmission opportunity 302-a, a first frame 304 to the AP 102-d. The first frame 304 may include an invitation for the AP 102-d to perform the joint CoBF procedure with the AP 102-c. For example, the first frame 304 may invite the AP 102-d to sound the STA 104-c (for example, start the joint CoBF procedure or perform a first portion or phase of the joint CoBF procedure) in the transmission opportunity 302-a. The first frame 304 may include first information associated with the first portion of the joint CoBF sounding procedure, as described with reference to FIG. 2. For example, the first information may indicate that the joint CoBF procedure is performed in two transmission opportunities 302. The transmission opportunity 302-a is to be used for sounding the STA 104-c and a transmission opportunity 302-b is to be used for sounding the STA 104-d.

The AP 102-d may transmit a second frame 306 to the AP 102-c to accept the invitation to perform the first portion of the joint CoBF sounding procedure. In some examples, the second frame 306 may include second information associated with the first portion of the joint CoBF sounding procedure, as described with reference to FIG. 2 (for example, indicate a MCS for communication of CSI 320-a). In such examples, the AP 102-d may transmit the second frame 306 after a short interframe space (SIFS) 308 from receiving the first frame 304. In accordance with the AP 102-d accepting the invitation from the AP 102-c, the APs 102 may perform the first portion of the joint CoBF sounding procedure in the transmission opportunity 302-a.

In some examples, as described with reference to FIG. 2, if the STA 104-c is operating according to a lower capability mode, the AP 102-c may determine (for example, prior to communication of the first frame 304) whether to refrain from communicating an ICF 310-a and an ICR 312-a with the STA 104-c. The AP 102-c may indicate the determination to the AP 102-d via the first information included in the first frame 304. For example, if the AP 102-c determines to communicate the ICF 310-a and the ICR 312-a, the AP 102-c may indicate the determination to the AP 102-d via the first frame 304. In such examples, the AP 102-c may transmit the ICF 310-a to indicate to the STA 104-c to operate according to the full capability mode. The STA 104-c may transmit an ICR 312-a indicating that the STA 104-c is operating according to the full capability mode.

If the AP 102-c determines to refrain from communicating the ICF 310-a and the ICR 312-a, the AP 102-c may indicate the determination to the AP 102-d via the first information included in the first frame 304. In such examples, the AP 102-c may indicate to the STA 104-c to operate according to the full capability mode via a management frame or the first frame announcing the start of the CoBF procedure, as described with reference to FIG. 2. In some other examples, if the STA 104-c is operating according to the full capability mode (obviating the ICF 310-a and the ICR 312-a), the AP 102-c may indicate the determination to refrain from communicating the ICF 310-a and the ICR 312-a to the AP 102-d via the first information included in the first frame 304. In this way, by indicating to the AP 102-d whether the ICF 310-a and the ICR 312-a are to be communicated, the AP 102-d may have an indication of a length of a transmission sequences associated with the CoBF procedure and have an indication of the timing of the NDPA 314-a (to which the NDP response is performed by the AP 102-d).

As part of the joint CoBF sounding procedure, the AP 102-c may transmit a NDPA 314-a, which may indicate one or more parameters associated with a NDP 316 to the STA 104-c and also may coordinate the joint sounding of an NDP 316-a and an NDP 316-b with the AP 102-d. According to the NDPA 314-a, the APs 102 may jointly sound the NDPs 316-a and 316-b. For example, the AP 102-c may sound the NDP 316-a and the AP 102-d may sound the NDP 316-b simultaneously, such that both NDPs 316 appear to be the same signal to the STA 104-c. In such examples, the APs 102 may sound the NDPs 316 according to the first information and/or the second information communicated via the first frame 304 and the second frame 306.

The STA 104-c may obtain CSI 320-a (for example, calculate large V based feedback, such as a feedback matrix or a steering matrix, as described with reference to FIG. 1) using the NDP 316-a and the NDP 316-b. The STA 104-c may receive, from the AP 102-c, a beamforming report poll (BFRP) frame 318-a requesting communication of the CSI 320-a. The STA 104-c may transmit the CSI 320-a to the AP 102-c. The AP 102-d may listen to the transmission of the CSI 320-a to also obtain the CSI 320-a.

As illustrated, the APs 102 may perform the first portion of the joint CoBF sounding procedure via the transmission opportunity 302-a. To initiate performance of the second portion of the joint CoBF sounding procedure (for example, sound the STA 104-d), the AP 102-d may transmit, in the transmission opportunity 302-b, for example, at a start of the transmission opportunity 302-b, a third frame 322 to the AP 102-c. The third frame 322 may include an invitation for the AP 102-c to perform the second portion of the joint CoBF procedure with the AP 102-d. For example, the third frame 322 may include an invitation to the AP 102-d to sound the STA 104-d in the transmission opportunity 302-b. The third frame 322 may include first information associated with the second portion of the joint CoBF sounding procedure for the STA 104-d, as described with reference to FIG. 2.

The AP 102-c may transmit a fourth frame 324 to the AP 102-d to accept the invitation to perform the second portion of the joint CoBF sounding procedure. In some examples, the fourth frame 324 may include second information associated with the second portion of the joint CoBF sounding procedure, as described with reference to FIG. 2 (for example, indicate a MCS for communication of CSI 320-b). In accordance with the AP 102-c accepting the invitation from the AP 102-d, the APs 102 may perform the second portion of the joint CoBF sounding procedure in the transmission opportunity 302-b.

In some examples, as described with reference to FIG. 2, if the STA 104-d is operating according to a lower capability mode, the AP 102-d may determine (for example, prior to communication of the third frame 322) whether to refrain from communicating an ICF 310-b and an ICR 312-b with the STA 104-d. The AP 102-d may indicate the determination to the AP 102-c via the first information included in the third frame 322. For example, if the AP 102-d determines to communicate the ICF 310-b and the ICR 312-b, the AP 102-d may indicate the determination to the AP 102-c via the third frame 322. In such examples, the AP 102-d may transmit the ICF 310-b to indicate to the STA 104-d to operate according to the full capability mode. The STA 104-d may transmit the ICR 312-b indicating that the STA 104-d is operating according to the full capability mode.

If the AP 102-d determines to refrain from communicating the ICF 310-b and the ICR 312-b, the AP 102-d may indicate the determination to the AP 102-c via the first information included in the third frame 322. In such examples, the AP 102-d may indicate to the STA 104-d to operate according to the full capability mode via a management frame or the first frame announcing the start of the CoBF procedure, as described with reference to FIG. 2. In some other examples, if the STA 104-d is operating according to the full capability mode (obviating the ICF 310-b and the ICR 312-b), the AP 102-d may indicate the determination to the AP 102-c via the first information included in the third frame 322. In this way, by indicating to the AP 102-c whether the ICF 310-b and the ICR 312-b are to be communicated, the AP 102-c may have an indication of a length of a transmission sequences associated with the CoBF procedure and have an indication of the timing of the NDPA 314-b (to which the NDP response is performed by the AP 102-c).

As part of the second portion of the joint CoBF sounding procedure, the AP 102-d may transmit a NDPA 314-b, which may indicate one or more parameters associated with a NDP 316 to the STA 104-d and also may coordinate the joint sounding of an NDP 316-c and an NDP 316-d with the AP 102-c. According to the NDPA 314-b, the APs 102 may jointly sound the NDPs 316-c and 316-d. For example, the AP 102-d may sound the NDP 316-c and the AP 102-c may sound the NDP 316-d simultaneously, such that both NDPs 316 appear to be the same signal to the STA 104-d. In such examples, the APs 102 may sound the NDPs 316 according to the first information and/or the second information communicated via the third frame 322 and the fourth frame 324.

The STA 104-c may obtain CSI 320-b (for example, calculate large V based feedback, as described with reference to FIG. 1) using the NDP 316-c and the NDP 316-d. The STA 104-d may receive, from the AP 102-d, a BFRP frame 318-b requesting communication of the CSI 320-b. The STA 104-d may transmit the CSI 320-b to the AP 102-d. The AP 102-c may listen to the transmission of the CSI 320-b to also obtain the CSI 320-b.

FIG. 4 shows an example of a timing diagram 400 that supports pre-sounding frames in CoBF sounding procedures. Aspects of the timing diagram 400 may implement, or be implemented by, examples of the wireless communication network 100, the process flow 200, and the timing diagram 300. For example, the timing diagram 400 may be implemented by an AP 102-e and an AP 102-f, which may be examples of APs 102. Further, the timing diagram 400 may be implemented by a STA 104-e and a STA 104-f, which may be examples of STAs 104. In such examples, the STA 104-e may be associated with the AP 102-e and may be participating in a CoBF sounding procedure, while the STA 104-f may be associated with the AP 102-f and may be participating in the CoBF sounding procedure. That is, the STA 104-e may be part of a first BSS of the AP 102-e and the STA 104-f may be part of a second BSS of the AP 102-f. The APs 102 and the STAs 104 may be referred to as wireless APs 102 and wireless STAs 104. The timing diagram 400 may illustrate coordination between the APs 102 prior to the performance of a sequential CoBF procedure in two transmission opportunities 402.

For example, the AP 102-e may transmit, via a transmission opportunity 402-a, for example, at a start of the transmission opportunity 402-a, a first frame 404 to the AP 102-f. The first frame 404 may include an invitation for the AP 102-f to perform the sequential CoBF procedure with the AP 102-e. For example, the first frame 404 may invite the AP 102-f to sound the STA 104-e (for example, perform a first portion or phase of the sequential CoBF procedure) in the transmission opportunity 402-a. The first frame 404 may include first information associated with the first portion of the sequential CoBF sounding procedure, as described with reference to FIG. 2. For example, the first information may indicate that the sequential CoBF procedure is performed in two transmission opportunities 402. The transmission opportunity 402-a is to be used for sounding the STA 104-e and a transmission opportunity 402-b is to be used for sounding the STA 104-f.

The AP 102-f may transmit a second frame 406 to the AP 102-e to accept the invitation to perform the first portion of the sequential CoBF sounding procedure. In some examples, the second frame 406 may include second information associated with the first portion of the sequential CoBF sounding procedure, as described with reference to FIG. 2 (for example, indicate a MCS for communication of CSI 420-b). In such examples, the AP 102-f may transmit the second frame 406 after a SIFS 408 from receiving the first frame 404. In accordance with the AP 102-f accepting the invitation from the AP 102-e, the APs 102 may perform the first portion of the sequential CoBF sounding procedure in the transmission opportunity 402-a.

In some examples, as described with reference to FIG. 2, if the STA 104-e is operating according to a lower capability mode, the AP 102-e may determine (for example, prior to communication of the first frame 404) whether to refrain from communicating an ICF 410-a and an ICR 412-a with the STA 104-e. The AP 102-e may indicate the determination to the AP 102-f via the first information included in the first frame 404. For example, if the AP 102-e determines to communicate the ICF 410-a and the ICR 412-a, the AP 102-e may indicate the determination to the AP 102-f via the first frame 404. In such examples, the AP 102-e may transmit the ICF 410-a to indicate to the STA 104-e to operate according to the full capability mode. The STA 104-e may transmit the ICR 412-a indicating that the STA 104-e is operating according to the full capability mode.

If the AP 102-e determines to refrain from communicating the ICF 410-a and the ICR 412-a, the AP 102-e may indicate the determination to the AP 102-f via the first information included in the first frame 404. In such examples, the AP 102-e may indicate to the STA 104-e to operate according to the full capability mode via a management frame or the first frame announcing the start of the CoBF procedure, as described with reference to FIG. 2. In some other examples, if the STA 104-e is operating according to the full capability mode (obviating the ICF 410-a and the ICR 412-a), the AP 102-e may indicate the determination to the AP 102-f via the first information included in the first frame 404. In this way, by indicating to the AP 102-f whether the ICF 410-a and the ICR 412-a are to be communicated, the AP 102-f may have an indication of a length of a transmission sequences associated with the CoBF procedure and have an indication of the timing of the NDPA 414-b (to which the NDP response is performed by the AP 102-f).

As part of the sequential CoBF sounding procedure, the AP 102-e may transmit a NDPA 414-a, which may indicate one or more parameters associated with communication of a NDP 416-a to the STA 104-e. According to the NDPA 414-a, the AP 102-e may sound the NDP 416-a. The STA 104-e may obtain (for example, calculate) CSI 420-a using the NDP 416-a. The STA 104-e may receive, from the AP 102-e, a BFRP frame 418-a requesting communication of the CSI 420-a. The STA 104-e may transmit the CSI 420-a to the AP 102-e.

According to obtaining the CSI 420-a, the AP 102-e may transmit the NDPA 414-b, which may indicate one or more parameters associated with communication of a NDP 416-b to the STA 104-e and indicate to the AP 102-f to communicate the NDP 416-b. The AP 102-f may sound the NDP 416-b. The STA 104-e may obtain (for example, calculate) CSI 420-b using the NDP 416-b. The AP 102-e may transmit the BFRP 418-b to trigger the STA 104-e to transmit the CSI 420-b. The AP 102-f may listen to the transmission of the CSI 420-b to obtain (for example, receive) the CSI 420-b From the Sta 104-e.

As illustrated, the APs 102 may perform the first portion of the sequential CoBF sounding procedure via the transmission opportunity 402-a. To initiate performance the second portion of the sequential CoBF sounding procedure (for example, sound the STA 104-f), the AP 102-f may transmit, via the transmission opportunity 402-b, for example, at a start of the transmission opportunity 402-b, a third frame 422 to the AP 102-e. The third frame 422 may include an invitation for the AP 102-e to perform the second portion of the sequential CoBF procedure with the AP 102-f. For example, the third frame 422 may include an invitation to the AP 102-e to sound the STA 104-f in the transmission opportunity 402-b. The third frame 422 may include first information associated with the second portion of the sequential CoBF sounding procedure for the STA 104-f, as described with reference to FIG. 2.

The AP 102-e may transmit a fourth frame 424 to the AP 102-f to accept the invitation to perform the second portion of the sequential CoBF sounding procedure. In some examples, the fourth frame 424 may include second information associated with the second portion of the sequential CoBF sounding procedure, as described with reference to FIG. 2 (for example, indicate a MCS for communication of CSI 420-d). In accordance with the AP 102-e accepting the invitation from the AP 102-f, the APs 102 may perform the second portion of the sequential CoBF sounding procedure in the transmission opportunity 402-b.

In some examples, as described with reference to FIG. 2, if the STA 104-f is operating according to a lower capability mode, the AP 102-f may determine (for example, prior to communication of the third frame 422) whether to refrain from communicating an ICF 410-b and an ICR 412-b with the STA 104-f. The AP 102-f may indicate the determination to the AP 102-e via the first information included in the third frame 422. For example, if the AP 102-f determines to communicate the ICF 410-b and the ICR 412-b, the AP 102-f may indicate the determination to the AP 102-e via the third frame 422. In such examples, the AP 102-f may transmit the ICF 410-b to indicate to the STA 104-f to operate according to the full capability mode. The STA 104-f may transmit the ICR 412-b indicating that the STA 104-f is operating according to the full capability mode.

If the AP 102-f determines to refrain from communicating the ICF 410-b and the ICR 412-b, the AP 102-f may indicate the determination to the AP 102-e via the first information included in the third frame 422. In such examples, the AP 102-f may indicate to the STA 104-f to operate according to the full capability mode via a management frame or the first frame announcing the start of the CoBF procedure, as described with reference to FIG. 2. In some other examples, if the STA 104-f is operating according to the full capability mode (obviating the ICF 410-b and the ICR 412-b), the AP 102-f may indicate the determination to refrain to the AP 102-e via the first information included in the third frame 422. In this way, by indicating to the AP 102-e whether the ICF 410-b and the ICR 412-b are to be communicated, the AP 102-e may have an indication of a length of a transmission sequences associated with the CoBF procedure and have an indication of the timing of the NDPA 414-d (to which the NDP response is performed by the AP 102-e).

As part of the second portion of the sequential CoBF sounding procedure, the AP 102-f may transmit a NDPA 414-c, which may indicate one or more parameters associated with communication of a NDP 416-c to the STA 104-f. According to the NDPA 414-c, the AP 102-f may sound the NDP 416-c. The STA 104-f may obtain (for example, calculate) CSI 420-c using the NDP 416-c. The STA 104-f may receive, from the AP 102-f, a BFRP frame 418-c requesting communication of the CSI 420-c. The STA 104-f may transmit the CSI 420-c to the AP 102-f.

According to obtaining the CSI 420-c, the AP 102-f may transmit the NDPA 414-d, which may indicate one or more parameters associated with communication of a NDP 416-d to the STA 104-f and indicate to the AP 102-e to communicate the NDP 416-d. The AP 102-e may sound the NDP 416-d. The STA 104-f may obtain (for example, calculate) CSI 420-d using the NDP 416-d. The AP 102-f may transmit the BFRP 418-d to trigger the STA 104-f to transmit the CSI 420-b. The AP 102-e may listen to the transmission of the CSI 420-d to obtain (for example, receive) the CSI 420-d from the STA 104-f.

FIG. 5 shows an example of a timing diagram 500 that supports pre-sounding frames in CoBF sounding procedures. Aspects of the timing diagram 500 may implement, or be implemented by, examples of the wireless communication network 100, the process flow 200, the timing diagram 300, and the timing diagram 400. For example, the timing diagram 500 may be implemented by an AP 102-g and an AP 102-h, which may be examples of APs 102-Further, the timing diagram 500 may be implemented by a STA 104-g and a STA 104-h, which may be examples of STAs 104. In such examples, the STA 104-g may be associated with the AP 102-g and may be participating in a CoBF sounding procedure, while the STA 104-h may be associated with the AP 102-h and may be participating in the CoBF sounding procedure. That is, the STA 104-g may be part of a first BSS of the AP 102-g and the STA 104-h may be part of a second BSS of the AP 102-h. The APs 102 and the STAs 104 may be referred to as wireless APs 102 and wireless STAs 104. The timing diagram 500 may illustrate coordination between the APs 102 prior to the performance of a joint CoBF procedure in a (single) transmission opportunity 502.

For example, the AP 102-g may transmit, via a transmission opportunity 502, for example, at a start of the transmission opportunity 502, a first frame 504 to the AP 102-h. The first frame 504 may include an invitation for the AP 102-h to perform the joint CoBF procedure with the AP 102-g. For example, the first frame 504 may invite the AP 102-h to sound the STA 104-g and the STA 104-h in the transmission opportunity 502. The first frame 504 may include first information associated with the first portion of the joint CoBF sounding procedure, as described with reference to FIG. 2. For example, the first information may indicate that the joint CoBF procedure is performed in the transmission opportunity 502.

The AP 102-h may transmit a second frame 506 to the AP 102-g to accept the invitation to perform the joint CoBF sounding procedure. In some examples, the second frame 506 may include second information associated with the joint CoBF sounding procedure, as described with reference to FIG. 2 (for example, indicate a MCS for communication of CSI 520-a). In such examples, the AP 102-h may transmit the second frame 506 after a SIFS 508 from receiving the first frame 504. In accordance with the AP 102-h accepting the invitation from the AP 102-g, the APs 102 may perform the joint CoBF sounding procedure in the transmission opportunity 502.

In some examples, as described with reference to FIG. 2, if the STA 104-g is operating according to a lower capability mode, the AP 102-g may determine (for example, prior to communication of the first frame 504) whether to refrain from communicating an ICF 510-a and an ICR 512-a with the STA 104-g. The AP 102-g may indicate the determination to the AP 102-h via the first information included in the first frame 504. For example, if the AP 102-g determines to communicate the ICF 510-a and the ICR 512-a, the AP 102-g may indicate the determination to the AP 102-h via the first frame 504. In such examples, the AP 102-g may transmit the ICF 510-a to indicate to the STA 104-g to operate according to the full capability mode. The STA 104-g may transmit an ICR 512-a indicating that the STA 104-g is operating according to the full capability mode.

If the AP 102-g determines to refrain from communicating the ICF 510-a and the ICR 512-a, the AP 102-g may indicate the determination to the AP 102-h via the first information included in the first frame 504. In such examples, the AP 102-g may indicate to the STA 104-g to operate according to the full capability mode via a management frame or the first frame announcing the start of the CoBF procedure, as described with reference to FIG. 2. In some other examples, if the STA 104-g is operating according to the full capability mode (obviating the ICF 510-a and the ICR 512-a), the AP 102-g may indicate the determination to the AP 102-h via the first information included in the first frame 504.

As part of the joint CoBF sounding procedure, the AP 102-g may transmit a NDPA 514-a, which may indicate one or more parameters associated with a NDP 516 to the STA 104-g and also may coordinate the joint sounding of an NDP 516-a and a NDP 516-b with the AP 102-h. According to the NDPA 514-a, the APs 102 may jointly sound the NDPs 516-a and 516-b. For example, the AP 102-g may sound the NDP 516-a and the AP 102-h may sound the NDP 516-b simultaneously, such that both NDPs 516 appear to be the same signal to the STA 104-g. In such examples, the APs 102 may sound the NDPs 516 according to the first information and/or the second information communicated via the first frame 504 and the second frame 506.

The STA 104-g may obtain CSI 520-a (for example, calculate large V based feedback, as described with reference to FIG. 1) using the NDP 516-a and the NDP 516-b. The STA 104-g may receive, from the AP 102-g, a BFRP frame 518-a requesting communication of the CSI 520-a. The STA 104-g may transmit the CSI 520-a to the AP 102-g. The AP 102-h may listen to the transmission of the CSI 520-a to also obtain (for example, receive) the CSI 520-a.

In accordance with sounding the STA 104-g, the AP 102-h and the AP 102-g may jointly sound the STA 104-h in the transmission opportunity 502 according to the first information and the second information communicated via the first frame 504 and the second frame 506, respectively. For example, as described with reference to FIG. 2, if the STA 104-h is operating according to a lower capability mode, the AP 102-h may determine (for example, prior to communication of the second frame 506) whether to refrain from communicating an ICF 510-b and an ICR 512-b with the STA 104-h. The AP 102-h may indicate the determination to the AP 102-g via the second information included in the second frame 506. For example, if the AP 102-h determines to communicate the ICF 510-b and the ICR 512-b, the AP 102-h may indicate the determination to the AP 102-g via the second frame 506. In such examples, the AP 102-h may transmit the ICF 510-b to indicate to the STA 104-h to operate according to the full capability mode. The STA 104-h may transmit the ICR 512-b indicating that the STA 104-h is operating according to the full capability mode.

If the AP 102-h determines to refrain from communicating the ICF 510-b and the ICR 512-b, the AP 102-h may indicate the determination to the AP 102-g via the second information included in the second frame 506. In such examples, the AP 102-h may indicate to the STA 104-h to operate according to the full capability mode via a management frame or the first frame announcing the start of the CoBF procedure, as described with reference to FIG. 2. In some other examples, if the STA 104-h is operating according to the full capability mode (obviating the ICF 510-b and the ICR 512-b), the AP 102-h may indicate the determination to the AP 102-g via the second information included in the second frame 506. In this way, by indicating to the AP 102-g whether the ICF 510-b and the ICR 512-b are to be communicated, the AP 102-g may have an indication of a length of a transmission sequences associated with the CoBF procedure and have an indication of the timing of the NDPA 514-b (to which the NDP response is performed by the AP 102-g).

The AP 102-g may transmit a NDPA 514-b, which may indicate one or more parameters associated with a NDP 516 to the STA 104-h and also may coordinate the joint sounding of an NDP 516-c and an NDP 516-d with the AP 102-g. According to the NDPA 514-b, the APs 102 may jointly sound the NDPs 516-c and 516-d. For example, the AP 102-h may sound the NDP 516-c and the AP 102-g may sound the NDP 516-d simultaneously, such that both NDPs 516 appear to be the same signal to the STA 104-h. In such examples, the APs 102 may sound the NDPs 516 according to the first information and/or the second information communicated via the first frame 504 and the second frame 506.

The STA 104-g may obtain CSI 520-b (for example, calculate large V based feedback, as described with reference to FIG. 1) using the NDP 516-c and the NDP 516-d. The STA 104-h may receive, from the AP 102-h, a BFRP frame 518-b requesting communication of the CSI 520-b. The STA 104-h may transmit the CSI 520-b to the AP 102-h. The AP 102-g may listen to the transmission of the CSI 520-b to also obtain (for example, receive) the CSI 520-b.

FIG. 6 shows an example of a timing diagram 600 that supports pre-sounding frames in CoBF sounding procedures. Aspects of the timing diagram 600 may implement, or be implemented by, examples of the wireless communication network 100, the process flow 200, the timing diagram 300, the timing diagram 400, and the timing diagram 500. For example, the timing diagram 600 may be implemented by an AP 102-i and an AP 102-j, which may be examples of APs 102. Further, the timing diagram 600 may be implemented by a STA 104-i and a STA 104-j, which may be examples of STAs 104. In such examples, the STA 104-i may be associated with the AP 102-i and may be participating in a CoBF sounding procedure, while the STA 104-j may be associated with the AP 102-j and may be participating in the CoBF sounding procedure. That is, the STA 104-i may be part of a first BSS of the AP 102-i and the STA 104-j may be part of a second BSS of the AP 102-j. The APs 102 and the STAs 104 may be referred to as wireless APs 102 and wireless STAs 104. The timing diagram 600 may illustrate coordination between the APs 102 prior to the performance of a sequential CoBF procedure in a (single) transmission opportunity 602.

For example, the AP 102-i may transmit, via the transmission opportunity 602, for example, at a start of the transmission opportunity 602, a first frame 604 to the AP 102-j. The first frame 604 may include an invitation for the AP 102-j to perform the sequential CoBF procedure with the AP 102-i. For example, the first frame 604 may invite the AP 102-j to sound the STA 104-i and the STA 104-j in the transmission opportunity 602. The first frame 604 may include first information associated with the sequential CoBF sounding procedure, as described with reference to FIG. 2. For example, the first information may indicate that the sequential CoBF procedure is performed in the (single) transmission opportunity 602.

The AP 102-j may transmit a second frame 606 to the AP 102-i to accept the invitation to perform the sequential CoBF sounding procedure. In some examples, the second frame 606 may include second information associated with the sequential CoBF sounding procedure, as described with reference to FIG. 2. In such examples, the AP 102-j may transmit the second frame 606 after a SIFS 608 from receiving the first frame 604. In accordance with the AP 102-j accepting the invitation from the AP 102-i, the APs 102 may perform the sequential CoBF sounding procedure in the transmission opportunity 602.

In some examples, as described with reference to FIG. 2, if the STA 104-i is operating according to a lower capability mode, the AP 102-i may determine (for example, prior to communication of the first frame 604) whether to refrain from communicating an ICF 610-a and an ICR 612-a with the STA 104-i. The AP 102-i may indicate the determination to the AP 102-j via the first information included in the first frame 604. For example, if the AP 102-i determines to communicate the ICF 610-a and the ICR 612-a, the AP 102-i may indicate the determination to the AP 102-j via the first frame 604. In such examples, the AP 102-i may transmit the ICF 610-a to indicate to the STA 104-i to operate according to the full capability mode. The STA 104-i may transmit the ICR 612-a indicating that the STA 104-i is operating according to the full capability mode.

If the AP 102-i determines to refrain from communicating the ICF 610-a and the ICR 612-a, the AP 102-i may indicate the determination to the AP 102-j via the first information included in the first frame 604. In such examples, the AP 102-i may indicate to the STA 104-i to operate according to the full capability mode via a management frame or the first frame announcing the start of the CoBF procedure, as described with reference to FIG. 2. In some other examples, if the STA 104-i is operating according to the full capability mode (obviating the ICF 610-a and the ICR 612-a), the AP 102-i may indicate the determination to refrain to the AP 102-j via the first information included in the first frame 604. In this way, by indicating to the AP 102-j whether the ICF 610-a and the ICR 612-a are to be communicated, the AP 102-j may have an indication of a length of a transmission sequences associated with the CoBF procedure and have an indication of the timing of the NDPA 614-b (to which the NDP response is performed by the AP 102-j).

As part of the sequential CoBF sounding procedure, the AP 102-i may transmit a NDPA 614-a, which may indicate one or more parameters associated with communication of a NDP 616-a to the STA 104-i. According to the NDPA 614-a, the AP 102-i may sound the NDP 616-a. The STA 104-i may obtain (for example, calculate) CSI 620-a using the NDP 616-a. The STA 104-i may receive, from the AP 102-i, a BFRP frame 618-a requesting communication of the CSI 620-a. The STA 104-i may transmit the CSI 620-a to the AP 102-i.

According to obtaining the CSI 620-a, the AP 102-i may transmit the NDPA 614-b, which may indicate one or more parameters associated with communication of a NDP 616-b to the STA 104-i and indicate to the AP 102-j to communicate the NDP 616-b. The AP 102-j may sound the NDP 616-b. The STA 104-i may obtain (for example, calculate) CSI 620-b using the NDP 616-b. The AP 102-i may transmit the BFRP 618-b to trigger the STA 104-i to transmit the CSI 620-b. The AP 102-j may listen to the transmission of the CSI 620-b to obtain (for example, receive) the CSI 620-b from the STA 104-i.

In accordance with sounding the STA 104-i, the APs 102 may proceed to sound the STA 104-j. For example, as described with reference to FIG. 2, if the STA 104-j is operating according to a lower capability mode, the AP 102-j may determine (for example, prior to communication of the second frame 606) whether to refrain from communicating an ICF 610-b and an ICR 612-b with the STA 104-j. The AP 102-j may indicate the determination to the AP 102-i via the second information included in the second frame 606. For example, if the AP 102-j determines to communicate the ICF 610-b and the ICR 612-b, the AP 102-j may indicate the determination to the AP 102-i via second information included in the second frame 606. In such examples, the AP 102-j may transmit the ICF 610-b to indicate to the STA 104-j to operate according to the full capability mode. The STA 104-j may transmit the ICR 612-b indicating that the STA 104-j is operating according to the full capability mode.

If the AP 102-j determines to refrain from communicating the ICF 610-b and the ICR 612-b, the AP 102-j may indicate the determination to the AP 102-i via the second information included in the second frame 606. In such examples, the AP 102-j may indicate to the STA 104-j to operate according to the full capability mode via a management frame or the first frame announcing the start of the CoBF procedure, as described with reference to FIG. 2. In some other examples, if the STA 104-j is operating according to the full capability mode (obviating the ICF 610-b and the ICR 612-b), the AP 102-j may indicate the determination to refrain to the AP 102-i via the second information included in the second frame 606. In this way, by indicating to the AP 102-i whether the ICF 610-b and the ICR 612-b are to be communicated, the AP 102-i may have an indication of a length of a transmission sequences associated with the CoBF procedure and have an indication of the timing of the NDPA 614-d (to which the NDP response is performed by the AP 102-i).

As part of the sequential CoBF sounding procedure for the STA 104-j, the AP 102-j may transmit a NDPA 614-c, which may indicate one or more parameters associated with communication of a NDP 616-c to the STA 104-j. According to the NDPA 614-c, the AP 102-j may sound the NDP 616-c. The STA 104-j may obtain (for example, calculate) CSI 620-c using the NDP 616-c. The STA 104-j may receive, from the AP 102-j, a BFRP frame 618-c requesting communication of the CSI 620-c. The STA 104-j may transmit the CSI 620-c to the AP 102-j.

According to obtaining the CSI 620-c, the AP 102-j may transmit the NDPA 614-d, which may indicate one or more parameters associated with communication of a NDP 616-d to the STA 104-j and indicate to the AP 102-i to communicate the NDP 616-d. The AP 102-i may sound the NDP 616-d. The STA 104-j may obtain (for example, calculate) CSI 620-d using the NDP 616-d. The AP 102-j may transmit the BFRP 618-d to trigger the STA 104-j to transmit the CSI 620-b. The AP 102-i may listen to the transmission of the CSI 620-d to obtain (for example, receive) the CSI 620-d from the STA 104-j.

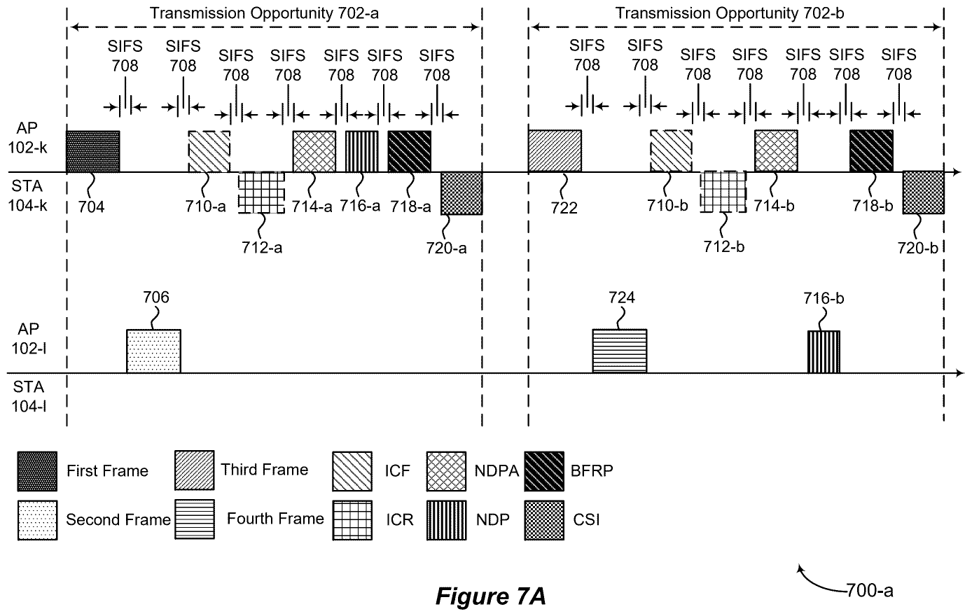

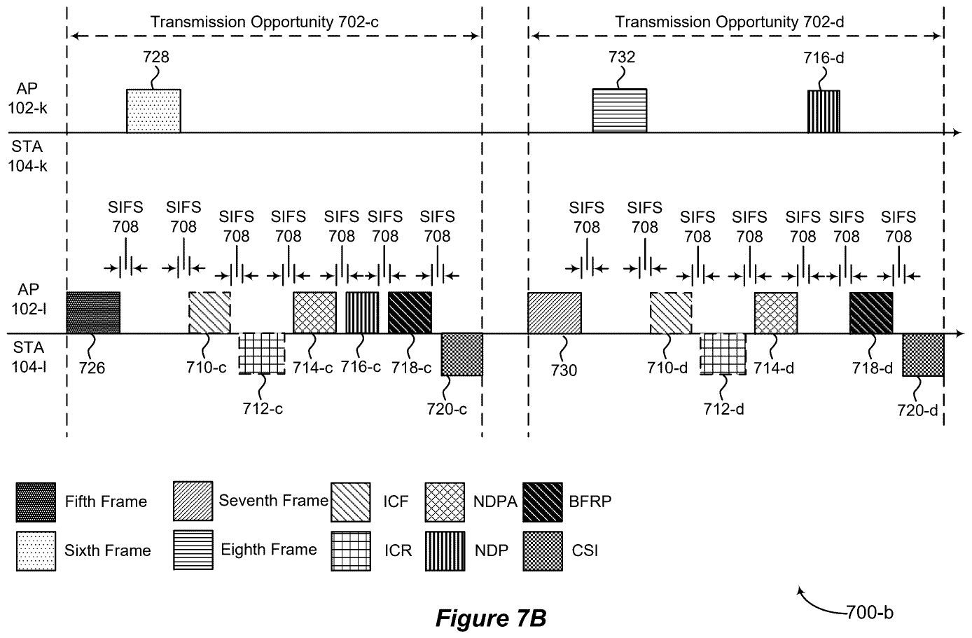

FIG. 7A and FIG. 7B show examples of a timing diagram 700-a and a timing diagram 700-b that support pre-sounding frames in CoBF sounding procedures. Aspects of the timing diagrams 700 may implement, or be implemented by, examples of the wireless communication network 100, the process flow 200, and the timing diagram 300. For example, the timing diagrams 700 may be implemented by an AP 102-k and an AP 102-l, which may be examples of APs 102. Further, the timing diagrams 700 may be implemented by a STA 104-k and a STA 104-l, which may be examples of STAs 104. In such examples, the STA 104-k may be associated with the AP 102-k and may be participating in a CoBF sounding procedure, while the STA 104-l may be associated with the AP 102-l and may be participating in the CoBF sounding procedure. That is, the STA 104-k may be part of a first BSS of the AP 102-k and the STA 104-l may be part of a second BSS of the AP 102-l. The APs 102 and the STAs 104 may be referred to as wireless APs 102 and wireless STAs 104.

The timing diagram 700 may illustrate coordination between the APs 102 prior to the performance of a sequential CoBF procedure in four transmission opportunities 702. In some examples, the techniques described in the timing diagrams 700 may be applicable in cases that AP 102-l is not available at the time of sounding. As such, the AP 102-k may proceed with collecting in-BSS CSI (CSI 720-a and 720-b) and subsequently poll the AP 102-l in a different transmission opportunity 702 to obtain the collect the OBSS CSI (CSI 720-c and 720-d). In some other examples, the techniques described in the timing diagrams 700 may be applicable in cases that the AP 102-k has received the in-BSS CSI from earlier transmission opportunities (transmission opportunities 702-a and 702-b) and instead proceed with collecting the cross-BSS CSI in the transmission opportunities 702-c and 702-d.

With reference to the timing diagram 700-a, the AP 102-k may transmit, via a transmission opportunity 702-a, for example, at a start of the transmission opportunity 702-a, a first frame 704 to the AP 102-l. The first frame 704 may include an invitation for the AP 102-l to perform the first portion of the sequential CoBF procedure with the AP 102-k. The first frame 704 may include first information associated with the first portion of the sequential CoBF sounding procedure, as described with reference to FIG. 2. In some examples, the first frame 704 my indicate that the sequential CoBF sounding procedure is divided into four portions and indicate that each portion is performed in a respective transmission opportunity 702.

The AP 102-l may transmit a second frame 706 to the AP 102-k to accept the invitation to perform the first portion of the sequential CoBF sounding procedure. In some examples, the second frame 706 may include second information associated with the first portion of the sequential CoBF sounding procedure, as described with reference to FIG. 2. In such examples, the AP 102-l may transmit the second frame 706 after a SIFS 708 from receiving the first frame 704. In accordance with the AP 102-l accepting the invitation from the AP 102-k, the APs 102 may perform the first portion of the sequential CoBF sounding procedure in the transmission opportunity 702-a.

In some examples, as described with reference to FIGS. 2 through 6, the AP 102-k may indicate whether an ICF 710-a and an ICR 712-a are to be communicated to the STA 104-k via the first information of the first frame 704. The AP 102-k may proceed to communicate or refrain from communicating the ICF 710-a and the ICR 712-a with the STA 104-k according to the first information included in the first frame 704.

As part of the first portion of the sequential CoBF sounding procedure, the AP 102-k may transmit a NDPA 714-a, which may indicate one or more parameters associated with communication of a NDP 716-a to the STA 104-k. According to the NDPA 714-a, the AP 102-k may sound the NDP 716-a. The STA 104-k may obtain (for example, calculate) the CSI 720-a using the NDP 716-a. The STA 104-k may receive, from the AP 102-k, a BFRP frame 718-a requesting communication of the CSI 720-a. The STA 104-k may transmit the CSI 720-a to the AP 102-k.

According to obtaining the CSI 720-a (for example, completion of the first portion of the sequential CoBF sounding procedure), the AP 102-k may initiate a second portion of the sequential CoBF sounding procedure with the AP 102-l. For example, the AP 102-k may transmit, at the start of a transmission opportunity 702-b, a third frame 722 that includes an invitation for the AP 102-l to perform a second portion of the sequential CoBF sounding procedure. That is, the third frame 722 may invite the AP 102-l to sound the STA 104-k. In such examples, the third frame 722 may include first information associated with the second portion of the sequential CoBF sounding procedure, as described with reference to FIG. 2.

The AP 102-l may transmit, to the AP 102-k and in accordance with receiving the third frame 722, a fourth frame 724 that indicates that the AP 102-l accepts the invitation for the AP 102-l to perform the second portion of the sequential CoBF sounding procedure. In such examples, the fourth frame 724 may include second information associated with the second portion of the sequential CoBF sounding procedure, as described with reference to FIG. 2.

According to the acceptance by the AP 102-l, the AP 102-k may indicate whether an ICF 710-b and an ICR 712-b are to be communicated to the STA 104-k via the first information of the third frame 722. The AP 102-k may proceed to communicate or refrain from communicating the ICF 710-b and the ICR 712-b with the STA 104-k according to the first information of the third frame 722.

As part of the second portion of the sequential CoBF procedure, the AP 102-k may transmit a NDPA 714-b, which may indicate one or more parameters associated with communication of a NDP 716-b to the STA 104-k and indicate to the AP 102-l to communicate the NDP 716-b. The AP 102-l may sound the NDP 716-b. The STA 104-k may obtain (for example, calculate) CSI 720-b using the NDP 716-b. The AP 102-k may transmit the BFRP 718-b to trigger the STA 104-k to transmit the CSI 720-b. The AP 102-l may listen to the transmission of the CSI 720-b to obtain (for example, receive) the CSI 720-b from the STA 104-k.

According to completion of the second portion of the sequential CoBF procedure and with reference to the timing diagram 700-b, the AP 102-l may initiate performance a third portion of the sequential CoBF sounding procedure (for example, sound the STA 104-l). For example, the AP 102-l may transmit, via the transmission opportunity 702-c, for example, at a start of the transmission opportunity 702-c, a fifth frame 726 to the AP 102-k. The fifth frame 726 may include an invitation for the AP 102-k to perform the third portion of the sequential CoBF procedure with the AP 102-l. The fifth frame 726 may include first information associated with the third portion of the sequential CoBF sounding procedure, as described with reference to FIG. 2.

The AP 102-k may transmit a sixth frame 728 to the AP 102-l to accept the invitation to perform the third portion of the sequential CoBF sounding procedure. In some examples, the sixth frame 728 may include second information associated with the third portion of the sequential CoBF sounding procedure, as described with reference to FIG. 2. In accordance with the AP 102-k accepting the invitation from the AP 102-l, the APs 102 may perform the third portion of the sequential CoBF sounding procedure in the transmission opportunity 702-c.

In some examples, as described with reference to FIGS. 2 through 6, the AP 102-l may indicate whether an ICF 710-c and an ICR 712-c are to be communicated to the STA 104-l via the first information of the fifth frame 726. The AP 102-l may proceed to communicate or refrain from communicating the ICF 710-c and the ICR 712-c with the STA 104-c according to the first information of the fifth frame 726.

As part of the third portion of the sequential CoBF sounding procedure, the AP 102-l may transmit a NDPA 714-c, which may indicate one or more parameters associated with communication of a NDP 716-c to the STA 104-l. According to the NDPA 714-c, the AP 102-l may sound the NDP 716-c. The STA 104-l may obtain (for example, calculate) CSI 720-c using the NDP 716-c. The STA 104-l may receive, from the AP 102-l, a BFRP frame 718-c requesting communication of the CSI 720-c. The STA 104-l may transmit the CSI 720-c to the AP 102-l.

According to obtaining the CSI 720-c (for example, completion of the third portion of the sequential CoBF sounding procedure), the AP 102-l may initiate a fourth portion of the sequential CoBF sounding procedure. For example, the AP 102-l may transmit, via a transmission opportunity 702-d, for example, at a start of the transmission opportunity 702-d, a seventh frame 730 that includes an invitation for the AP 102-k to perform the fourth portion of the sequential CoBF sounding procedure. That is, the seventh frame 730 may invite the AP 102-k to sound the STA 104-k as part of the fourth portion of the sequential CoBF sounding procedure. In such examples, the seventh frame 730 may include first information associated with the fourth portion of the sequential CoBF sounding procedure, as described with reference to FIG. 2.

The AP 102-k may transmit, in accordance with receiving the seventh frame 730, an eighth frame 732 accepting the invitation to perform the fourth portion of the sequential CoBF sounding procedure. In such examples, the eighth frame 732 may indicate second information associated with the fourth portion of the sequential CoBF sounding procedure, as described with reference to FIG. 2. In accordance with the AP 102-k accepting the invitation from the AP 102-l, the APs 102 may perform the fourth portion of the sequential CoBF sounding procedure in the transmission opportunity 702-d.

In some examples, as described with reference to FIGS. 2 through 6, the AP 102-l may indicate whether an ICF 710-d and an ICR 712-d are to be communicated to the STA 104-l via the first information of the seventh frame 730. The AP 102-l may proceed to communicate or refrain from communicating the ICF 710-d and the ICR 712-d with the STA 104-l according to the first information of the seventh frame 730.

As part of the fourth portion of the sequential CoBF sounding procedure, the AP 102-l may transmit a NDPA 714-d, which may indicate one or more parameters associated with communication of a NDP 716-d to the STA 104-l and indicate to the AP 102-k to communicate the NDP 716-d. The AP 102-k may sound the NDP 716-d. The STA 104-l may obtain (for example, calculate) CSI 720-d using the NDP 716-d. The AP 102-l may transmit the BFRP 718-d to trigger the STA 104-l to transmit the CSI 720-b. The AP 102-k may listen to the transmission of the CSI 720-d to obtain (for example, receive) the CSI 720-d from the STA 104-l.

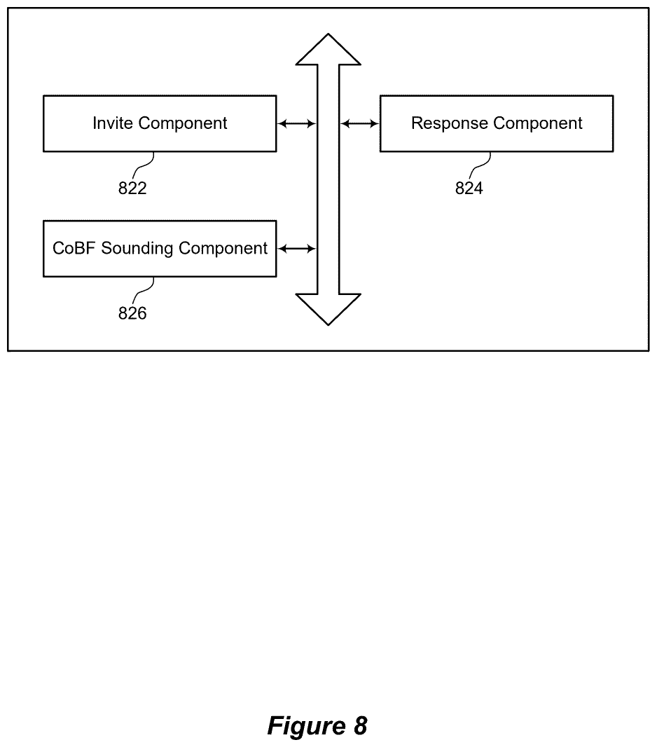

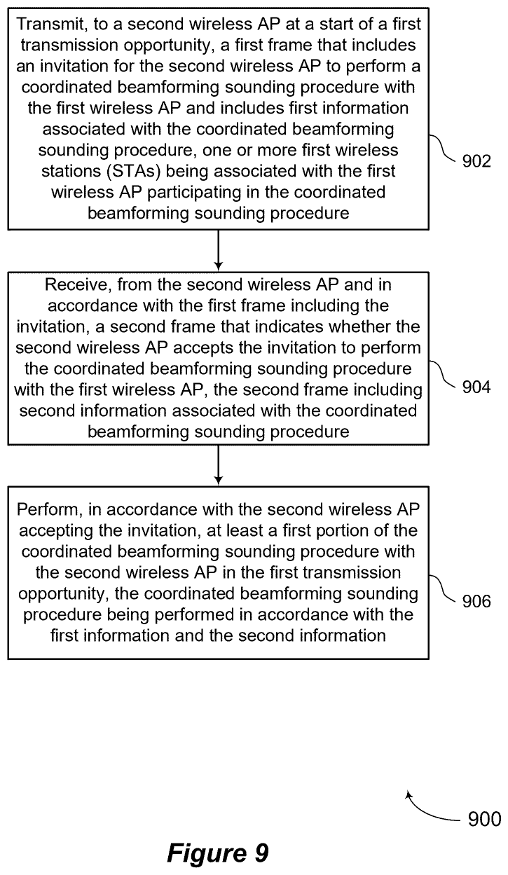

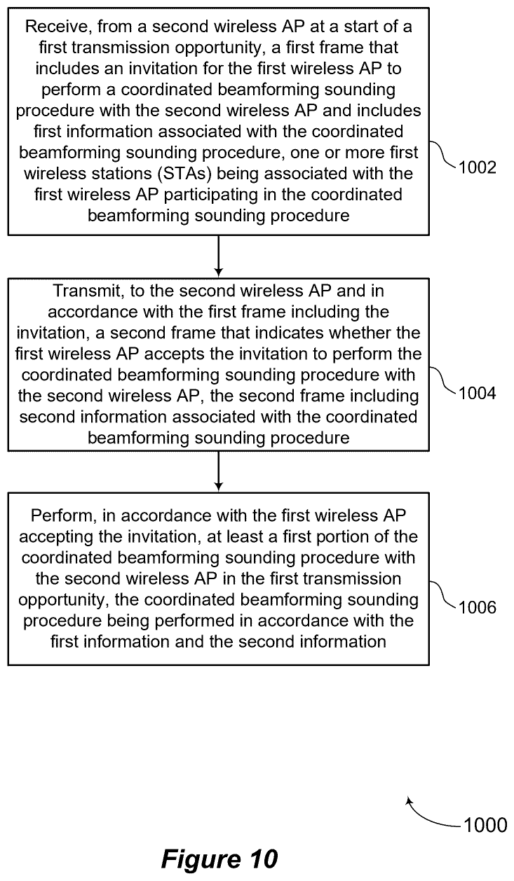

FIG. 8 shows a block diagram of an example wireless communication device that supports pre-sounding frames in CoBF sounding procedures. In some examples, the wireless communication device is configured to perform the processes 900 and 1000 described with reference to FIGS. 9 and 10, respectively. The wireless communication device may include one or more chips, SoCs, chipsets, packages, components or devices that individually or collectively constitute or include a processing system. The processing system may interface with other components of the wireless communication device, and may generally process information (such as inputs or signals) received from such other components and output information (such as outputs or signals) to such other components. In some examples, an example chip may include a processing system, a first interface to output or transmit information and a second interface to receive or obtain information. For example, the first interface may refer to an interface between the processing system of the chip and a transmission component, such that the wireless communication device may transmit the information output from the chip. In such an example, the second interface may refer to an interface between the processing system of the chip and a reception component, such that the wireless communication device may receive information that is then passed to the processing system. In some such examples, the first interface also may obtain information, such as from the transmission component, and the second interface also may output information, such as to the reception component.

The processing system of the wireless communication device includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device can be configurable or configured for use in an AP, such as the AP 102 described with reference to FIG. 1. In some other examples, the wireless communication device can be an AP that includes such a processing system and other components including multiple antennas. The processing system may cause (for example, enable or facilitate performance at) the AP to perform one or more aspects of pre-frame sounding exchanges for CoBF sounding procedures. The wireless communication device is capable of transmitting and receiving wireless communications in the form of, for example, wireless packets. For example, the wireless communication device can be configurable or configured to transmit and receive packets in the form of physical layer PPDUs and MPDUs conforming to one or more of the IEEE 802.11 family of wireless communication protocol standards. In some other examples, the wireless communication device can be configurable or configured to transmit and receive signals and communications conforming to one or more 3GPP specifications including those for 5G NR or 6G. In some examples, the wireless communication device also includes or can be coupled with one or more application processors which may be further coupled with one or more other memories. In some examples, the wireless communication device further includes at least one external network interface coupled with the processing system that enables (for example, causes) communication with a core network or backhaul network that enables the wireless communication device to gain access to external networks including the Internet.

The wireless communication device includes an invite component 822, a response component 824, and a CoBF Sounding Component 826. Portions of one or more of the invite component 822, the response component 824, and the CoBF Sounding Component 826 may be implemented at least in part in hardware or firmware. For example, one or more of the invite component 822, the response component 824, and the CoBF Sounding Component 826 may be implemented at least in part by at least a processor or a modem. In some examples, portions of one or more of the invite component 822, the response component 824, and the CoBF Sounding Component 826 may be implemented at least in part by a processor and software in the form of processor-executable code stored in memory.

The wireless communication device may support wireless communication in accordance with examples as disclosed herein and may, for example, be an example of an AP 102-a. The invite component 822 is configurable or configured to transmit, to a second wireless AP (such as an AP 102-b) at a start of a first transmission opportunity, a first frame that includes an invitation for the second wireless AP to perform a CoBF sounding procedure with the first wireless AP and includes first information associated with the CoBF sounding procedure, one or more first wireless STAs being associated with the first wireless AP participating in the coordinated beamforming sounding procedure. The response component 824 is configurable or configured to receive, from the second wireless AP and in accordance with the first frame including the invitation, a second frame that indicates whether the second wireless AP accepts the invitation to perform the CoBF sounding procedure with the first wireless AP, the second frame including second information associated with the CoBF sounding procedure. The CoBF Sounding Component 826 is configurable or configured to perform, in accordance with the second wireless AP accepting the invitation, at least a first portion of the CoBF sounding procedure with the second wireless AP in the first transmission opportunity, the CoBF sounding procedure being performed in accordance with the first information and the second information.

In some examples, the invite component 822 is configurable or configured to transmit, to a third wireless AP at a start of a second transmission opportunity, a third frame that includes a second invitation for the third wireless AP to perform a second CoBF sounding procedure with the first wireless AP. In some examples, the response component 824 is configurable or configured to refrain from performing the second CoBF sounding procedure in accordance with the third wireless AP declining the second invitation.

In some examples, the invite component 822 is configurable or configured to receive a fourth frame that indicates the third wireless AP declines the invitation, where refraining from performing the second CoBF sounding procedure is in accordance with the fourth frame.

In some examples, the fourth frame indicates a reason for declining the invitation. In some examples, the reason includes one or more of an indication that the third wireless AP is in agreement with one or more other wireless APs for CoBF, an indication that the third wireless AP has reached a threshold quantity of CoBF agreements supported by the third wireless AP, an indication that traffic associated with one or more third wireless STAs is insufficient for the CoBF sounding procedure, an indication that the one or more third wireless STAs have one or more operation modes enabled that are incompatible with the CoBF sounding procedure, an indication that the first wireless AP has failed to successfully receive CSI from the one or more third wireless STAs, or an indication that the one or more third wireless STAs are not candidates for performing the CoBF sounding procedure.

In some examples, refraining from performing the second CoBF sounding procedure is in accordance with a failure to receive a response from the third wireless AP.

In some examples, the invite component 822 is configurable or configured to transmit, to the third wireless AP at a start of a third transmission opportunity, a fourth frame that includes a third invitation for the third wireless AP to perform a third CoBF sounding procedure with the first wireless AP.

In some examples, the at least first portion of the CoBF sounding procedure is performed in the first transmission opportunity and a second portion of the CoBF sounding procedure is performed in a second transmission opportunity, and the invite component 822 is configurable or configured to receive, from the second wireless AP at a start of the second transmission opportunity, a third frame including a second invitation to perform the second portion of the CoBF sounding procedure. In some examples, the at least first portion of the CoBF sounding procedure is performed in the first transmission opportunity and a second portion of the CoBF sounding procedure is performed in a second transmission opportunity, and the response component 824 is configurable or configured to transmit, to the second wireless AP and in accordance with the third frame including the second invitation, a fourth frame indicating that the first wireless AP accepts the second invitation.

In some examples, the CoBF sounding procedure is performed in the first transmission opportunity.

In some examples, the first information indicates a quantity of transmission opportunities in which the CoBF sounding procedure is to be performed, or the second information indicates the quantity of transmission opportunities in which the CoBF sounding procedure is to be performed.

In some examples, the first information indicates a first quantity of spatial streams supported for reception of sounding packets by the one or more first wireless STAs, the second information indicates a second quantity of spatial streams supported for reception of the sounding packets by one or more second wireless STAs, and the CoBF sounding procedure is performed in accordance with one of the first quantity of spatial streams or the second quantity of spatial streams.

In some examples, the first information indicates a first quantity of LTFs supported for reception of sounding packets by the one or more first wireless STAs, the second information indicates a second quantity of LTFs supported for reception of the sounding packets by one or more second wireless STAs, and the CoBF sounding procedure is performed in accordance with one of the first quantity of LTFs or the second quantity of LTFs.

In some examples, the first wireless AP is a synchronization reference for the CoBF sounding procedure in accordance with transmission of the first frame to the second wireless AP, and the CoBF Sounding Component 826 is configurable or configured to transmit, to the second wireless AP, one or more synchronization signals, where a timing, a phase, a frequency, or any combination thereof, of one or more sounding packets from the second wireless AP are in accordance with the one or more synchronization signals.

In some examples, the first information indicates that one of the first wireless AP or the second wireless AP is a synchronization reference for the CoBF sounding procedure.

In some examples, the first information indicates whether to refrain from communicating a first ICF and a first ICR frame with the one or more first wireless STAs as part of the CoBF sounding procedure in accordance with a first mode in which the one or more first wireless STAs are operating, and the second information indicates whether to refrain from communicating a second ICF and a second ICR frame with one or more second wireless STAs as part of the CoBF sounding procedure in accordance with a second mode in which the one or more second wireless STAs are operating.

In some examples, the CoBF Sounding Component 826 is configurable or configured to transmit, to the one or more first wireless STAs, a management frame, a control frame, or both, that indicates to the one or more first wireless STAs to disable a first mode at the one or more first wireless STAs, where the first information indicates to refrain from communicating the first ICF and the first ICR frame in accordance with the management frame, the control frame, or both.

Additionally, or alternatively, the wireless communication device may support wireless communication in accordance with examples as disclosed herein and may be an example of an AP 102-b. In some examples, the invite component 822 is configurable or configured to receive, from a second wireless AP (such as an AP 102-a) at a start of a first transmission opportunity, a first frame that includes an invitation for the first wireless AP to perform a CoBF sounding procedure with the second wireless AP and includes first information associated with the CoBF sounding procedure, one or more first wireless STAs being associated with the first wireless AP participating in the coordinated beamforming sounding procedure. In some examples, the response component 824 is configurable or configured to transmit, to the second wireless AP and in accordance with the first frame including the invitation, a second frame that indicates whether the first wireless AP accepts the invitation to perform the CoBF sounding procedure with the second wireless AP, the second frame including second information associated with the CoBF sounding procedure. In some examples, the CoBF Sounding Component 826 is configurable or configured to perform, in accordance with the first wireless AP accepting the invitation, at least a first portion of the CoBF sounding procedure with the second wireless AP in the first transmission opportunity, the CoBF sounding procedure being performed in accordance with the first information and the second information.

In some examples, the invite component 822 is configurable or configured to receive, from a third wireless AP at a start of a second transmission opportunity, a third frame that includes a second invitation for the first wireless AP to perform a second CoBF sounding procedure with the third wireless AP. In some examples, the response component 824 is configurable or configured to decline the second invitation to perform the second CoBF sounding procedure with the third wireless AP.

In some examples, the response component 824 is configurable or configured to transmit, to the third wireless AP, a fourth frame that indicates the first wireless AP declines the invitation.

In some examples, the fourth frame indicates a reason for declining the invitation. In some examples, the reason includes one or more of an indication that the first wireless AP is in agreement with one or more other wireless APs for CoBF, an indication that the first wireless AP has reached a threshold quantity of CoBF agreements supported by the first wireless AP, an indication that traffic associated with the one or more first wireless STAs is insufficient for the CoBF sounding procedure, an indication that the one or more first wireless STAs have one or more operation modes enabled that are incompatible with the CoBF sounding procedure, an indication that the third wireless AP has failed to successfully receive CSI from the one or more first wireless STAs, or an indication that the one or more first wireless STAs are not candidates for performing the CoBF sounding procedure.

In some examples, the response component 824 is configurable or configured to refrain from transmitting a response to the third wireless AP in accordance with an engagement with another wireless device, in accordance with hidden transmissions from the third wireless AP, or both, where declining the second invitation is in accordance with refraining from transmitting the response.

In some examples, the invite component 822 is configurable or configured to receive, from the third wireless AP at a start of a third transmission opportunity, a fourth frame that includes a third invitation for the first wireless AP to perform a third CoBF sounding procedure with the third wireless AP.

In some examples, the at least first portion of the CoBF sounding procedure is performed in the first transmission opportunity and a second portion of the CoBF sounding procedure is performed in a second transmission opportunity, and the invite component 822 is configurable or configured to transmit, to the second wireless AP at a start of the second transmission opportunity, a third frame including a second invitation to perform the second portion of the CoBF sounding procedure. In some examples, the at least first portion of the CoBF sounding procedure is performed in the first transmission opportunity and a second portion of the CoBF sounding procedure is performed in a second transmission opportunity, and the response component 824 is configurable or configured to receive, from the second wireless AP and in accordance with the third frame including the second invitation, a fourth frame indicating that the second wireless AP accepts the second invitation.

In some examples, the CoBF sounding procedure is performed in the first transmission opportunity.

In some examples, the first information indicates a quantity of transmission opportunities in which the CoBF sounding procedure is to be performed, or the second information indicates the quantity of transmission opportunities in which the CoBF sounding procedure is to be performed.

In some examples, the first information indicates a first quantity of spatial streams supported for reception of sounding packets by the one or more first wireless STAs, the second information indicates a second quantity of spatial streams supported for reception of the sounding packets by one or more second wireless STAs, and the CoBF sounding procedure is performed in accordance with one of the first quantity of spatial streams or the second quantity of spatial streams.

In some examples, the first information indicates a first quantity of LTFs supported for reception of sounding packets by the one or more first wireless STAs, the second information indicates a second quantity of LTFs supported for reception of the sounding packets by one or more second wireless STAs, and the CoBF sounding procedure is performed in accordance with one of the first quantity of LTFs or the second quantity of LTFs.

In some examples, the first wireless AP is a synchronization follower for the CoBF sounding procedure in accordance with reception of the first frame from the first wireless AP, and the CoBF Sounding Component 826 is configurable or configured to receive, from the first wireless AP, one or more synchronization signals. In some examples, the first wireless AP is a synchronization follower for the CoBF sounding procedure in accordance with reception of the first frame from the first wireless AP, and the CoBF Sounding Component 826 is configurable or configured to synchronize a time, a phase, a frequency, or any combination thereof, of one or more sounding packets according to the one or more synchronization signals.

In some examples, the first information indicates that one of the first wireless AP or the second wireless AP is a synchronization reference for the CoBF sounding procedure.

In some examples, the first information indicates whether to refrain from communicating a first ICF and a first ICR frame with one or more second wireless STAs as part of the CoBF sounding procedure in accordance with a first mode in which the one or more second wireless STAs are operating, and the second information indicates whether to refrain from communicating a second ICF and a second ICR frame to the one or more first wireless STAs as part of the CoBF sounding procedure in accordance with a second mode in which the one or more first wireless STAs are operating.

In some examples, the CoBF Sounding Component 826 is configurable or configured to transmit, to the one or more first wireless STAs, a management frame, a control frame, or both, that indicates to the one or more first wireless STAs to disable a first mode at the one or more first wireless STAs, where the second information indicates to refrain from communicating the second ICF and the second ICR frame in accordance with the management frame, the control frame, or both.

FIG. 9 shows a flowchart illustrating an example process 900 performable by or at a first wireless AP that supports pre-sounding frames in CoBF sounding procedures. The operations of the process 900 may be implemented by a first wireless AP or its components as described herein. For example, the process 900 may be performed by a wireless communication device, such as the wireless communication device described with reference to FIG. 8, operating as or within a wireless AP. In some examples, the process 900 may be performed by a wireless AP, such as one of the APs 102 described with reference to FIG. 1.

In some examples, in 902, the first wireless AP may transmit, to a second wireless AP at a start of a first transmission opportunity, a first frame that includes an invitation for the second wireless AP to perform a CoBF sounding procedure with the first wireless AP and includes first information associated with the CoBF sounding procedure, one or more first wireless STAs being associated with the first wireless AP participating in the coordinated beamforming sounding procedure. The operations of 902 may be performed in accordance with examples as disclosed herein. In some implementations, examples of the operations of 902 may be performed by an invite component 822 as described with reference to FIG. 8.

In some examples, in 904, the first wireless AP may receive, from the second wireless AP and in accordance with the first frame including the invitation, a second frame that indicates whether the second wireless AP accepts the invitation to perform the CoBF sounding procedure with the first wireless AP, the second frame including second information associated with the CoBF sounding procedure. The operations of 904 may be performed in accordance with examples as disclosed herein. In some implementations, examples of the operations of 904 may be performed by a response component 824 as described with reference to FIG. 8.

In some examples, in 906, the first wireless AP may perform, in accordance with the second wireless AP accepting the invitation, at least a first portion of the CoBF sounding procedure with the second wireless AP in the first transmission opportunity, the CoBF sounding procedure being performed in accordance with the first information and the second information. The operations of 906 may be performed in accordance with examples as disclosed herein. In some implementations, examples of the operations of 906 may be performed by a CoBF Sounding Component 826 as described with reference to FIG. 8.

FIG. 10 shows a flowchart illustrating an example process 1000 performable by or at a first wireless AP that supports pre-sounding frames in CoBF sounding procedures. The operations of the process 1000 may be implemented by a first wireless AP or its components as described herein. For example, the process 1000 may be performed by a wireless communication device, such as the wireless communication device described with reference to FIG. 8, operating as or within a wireless AP. In some examples, the process 1000 may be performed by a wireless AP, such as one of the APs 102 described with reference to FIG. 1.

In some examples, in 1002, the first wireless AP may receive, from a second wireless AP at a start of a first transmission opportunity, a first frame that includes an invitation for the first wireless AP to perform a CoBF sounding procedure with the second wireless AP and includes first information associated with the CoBF sounding procedure, one or more first wireless STAs being associated with the first wireless AP participating in the coordinated beamforming sounding procedure. The operations of 1002 may be performed in accordance with examples as disclosed herein. In some implementations, examples of the operations of 1002 may be performed by an invite component 822 as described with reference to FIG. 8.

In some examples, in 1004, the first wireless AP may transmit, to the second wireless AP and in accordance with the first frame including the invitation, a second frame that indicates whether the first wireless AP accepts the invitation to perform the CoBF sounding procedure with the second wireless AP, the second frame including second information associated with the CoBF sounding procedure. The operations of 1004 may be performed in accordance with examples as disclosed herein. In some implementations, examples of the operations of 1004 may be performed by a response component 824 as described with reference to FIG. 8.

In some examples, in 1006, the first wireless AP may perform, in accordance with the first wireless AP accepting the invitation, at least a first portion of the CoBF sounding procedure with the second wireless AP in the first transmission opportunity, the CoBF sounding procedure being performed in accordance with the first information and the second information. The operations of 1006 may be performed in accordance with examples as disclosed herein. In some implementations, examples of the operations of 1006 may be performed by a CoBF Sounding Component 826 as described with reference to FIG. 8.

Implementation examples are described in the following numbered clauses:

The following provides an overview of aspects of the present disclosure:

Aspect 1: A method for wireless communication by a first wireless AP, comprising: transmitting, to a second wireless AP at a start of a first transmission opportunity, a first frame that comprises an invitation for the second wireless AP to perform a CoBF sounding procedure with the first wireless AP and comprises first information associated with the CoBF sounding procedure, one or more first wireless STAs being associated with the first wireless AP participating in the CoBF sounding procedure; receiving, from the second wireless AP and in accordance with the first frame comprising the invitation, a second frame that indicates whether the second wireless AP accepts the invitation to perform the CoBF sounding procedure with the first wireless AP, the second frame comprising second information associated with the CoBF sounding procedure; and performing, in accordance with the second wireless AP accepting the invitation, at least a first portion of the CoBF sounding procedure with the second wireless AP in the first transmission opportunity, the CoBF sounding procedure being performed in accordance with the first information and the second information.

Aspect 2: The method of aspect 1, further comprising: transmitting, to a third wireless AP at a start of a second transmission opportunity, a third frame that comprises a second invitation for the third wireless AP to perform a second CoBF sounding procedure with the first wireless AP; and refraining from performing the second CoBF sounding procedure in accordance with the third wireless AP declining the second invitation.

Aspect 3: The method of aspect 2, further comprising receiving a fourth frame that indicates the third wireless AP declines the invitation, wherein refraining from performing the second CoBF sounding procedure is in accordance with the fourth frame.

Aspect 4: The method of aspect 3, wherein the fourth frame indicates a reason for declining the invitation, and the reason comprises one or more of an indication that the third wireless AP is in agreement with one or more other wireless APs for CoBF, an indication that the third wireless AP has reached a threshold quantity of CoBF agreements supported by the third wireless AP, an indication that traffic associated with one or more third wireless STAs is insufficient for the CoBF sounding procedure, an indication that the one or more third wireless STAs have one or more operation modes enabled that are incompatible with the CoBF sounding procedure, an indication that the first wireless AP has failed to successfully receive CSI from the one or more third wireless STAs, or an indication that the one or more third wireless STAs are not candidates for performing the CoBF sounding procedure.

Aspect 5: The method of any of aspects 2 through 4, wherein refraining from performing the second CoBF sounding procedure is in accordance with a failure to receive a response from the third wireless AP.

Aspect 6: The method of aspect 5, further comprising transmitting, to the third wireless AP at a start of a third transmission opportunity, a fourth frame that comprises a third invitation for the third wireless AP to perform a third CoBF sounding procedure with the first wireless AP.

Aspect 7: The method of any of aspects 1 through 6, wherein the at least first portion of the CoBF sounding procedure is performed in the first transmission opportunity and a second portion of the CoBF sounding procedure is performed in a second transmission opportunity, and wherein the first frame and the second frame are communicated at the start of the first transmission opportunity, the method further comprising: receiving, from the second wireless AP at a start of the second transmission opportunity, a third frame comprising a second invitation to perform the second portion of the CoBF sounding procedure; and transmitting, to the second wireless AP and in accordance with the third frame comprising the second invitation, a fourth frame indicating that the first wireless AP accepts the second invitation.

Aspect 8: The method of any of aspects 1 through 7, wherein the CoBF sounding procedure is performed in the first transmission opportunity.

Aspect 9: The method of any of aspects 1 through 8, wherein the first information indicates a quantity of transmission opportunities in which the CoBF sounding procedure is to be performed, or the second information indicates the quantity of transmission opportunities in which the CoBF sounding procedure is to be performed.

Aspect 10: The method of any of aspects 1 through 9, wherein the first information indicates a first quantity of spatial streams supported for reception of sounding packets by the one or more first wireless STAs, the second information indicates a second quantity of spatial streams supported for reception of the sounding packets by one or more second wireless STAs, and the CoBF sounding procedure is performed in accordance with one of the first quantity of spatial streams or the second quantity of spatial streams.

Aspect 11: The method of any of aspects 1 through 10, wherein the first information indicates a first quantity of LTFs supported for reception of sounding packets by the one or more first wireless STAs, the second information indicates a second quantity of LTFs supported for reception of the sounding packets by one or more second wireless STAs, and the CoBF sounding procedure is performed in accordance with one of the first quantity of LTFs or the second quantity of LTFs.

Aspect 12: The method of any of aspects 1 through 11, wherein the first wireless AP is a synchronization reference for the CoBF sounding procedure in accordance with transmission of the first frame to the second wireless AP, the method further comprising: transmitting, to the second wireless AP, one or more synchronization signals, wherein a timing, a phase, a frequency, or any combination thereof, of one or more sounding packets from the second wireless AP are in accordance with the one or more synchronization signals.

Aspect 13: The method of any of aspects 1 through 12, wherein the first information indicates that one of the first wireless AP or the second wireless AP is a synchronization reference for the CoBF sounding procedure.

Aspect 14: The method of any of aspects 1 through 13, wherein the first information indicates whether to refrain from communicating a first initial control frame and a first initial control response frame with the one or more first wireless STAs as part of the CoBF sounding procedure in accordance with a first mode in which the one or more first wireless STAs are operating, and the second information indicates whether to refrain from communicating a second initial control frame and a second initial control response frame with one or more second wireless STAs as part of the CoBF sounding procedure in accordance with a second mode in which the one or more second wireless STAs are operating.

Aspect 15: The method of aspect 14, further comprising transmitting, to the one or more first wireless STAs, a management frame, a control frame, or both, that indicates to the one or more first wireless STAs to disable a first mode at the one or more first wireless STAs, wherein the first information indicates to refrain from communicating the first initial control frame and the first initial control response frame in accordance with the management frame, the control frame, or both.

Aspect 16: A method for wireless communication by a first wireless AP, comprising: receiving, from a second wireless AP at a start of a first transmission opportunity, a first frame that comprises an invitation for the first wireless AP to perform a CoBF sounding procedure with the second wireless AP and comprises first information associated with the CoBF sounding procedure, one or more first wireless STAs being associated with the first wireless AP participating in the CoBF sounding procedure; transmitting, to the second wireless AP and in accordance with the first frame comprising the invitation, a second frame that indicates whether the first wireless AP accepts the invitation to perform the CoBF sounding procedure with the second wireless AP, the second frame comprising second information associated with the CoBF sounding procedure; and performing, in accordance with the first wireless AP accepting the invitation, at least a first portion of the CoBF sounding procedure with the second wireless AP in the first transmission opportunity, the CoBF sounding procedure being performed in accordance with the first information and the second information.

Aspect 17: The method of aspect 16, further comprising: receiving, from a third wireless AP at a start of a second transmission opportunity, a third frame that comprises a second invitation for the first wireless AP to perform a second CoBF sounding procedure with the third wireless AP; and declining the second invitation to perform the second CoBF sounding procedure with the third wireless AP.

Aspect 18: The method of aspect 17, further comprising transmitting, to the third wireless AP, a fourth frame that indicates the first wireless AP declines the invitation.

Aspect 19: The method of aspect 18, wherein the fourth frame indicates a reason for declining the invitation, and the reason comprises one or more of an indication that the first wireless AP is in agreement with one or more other wireless APs for CoBF, an indication that the first wireless AP has reached a threshold quantity of CoBF agreements supported by the first wireless AP, an indication that traffic associated with the one or more first wireless STAs is insufficient for the CoBF sounding procedure, an indication that the one or more first wireless STAs have one or more operation modes enabled that are incompatible with the CoBF sounding procedure, an indication that the third wireless AP has failed to successfully receive CSI from the one or more first wireless STAs, or an indication that the one or more first wireless STAs are not candidates for performing the CoBF sounding procedure.

Aspect 20: The method of any of aspects 17 through 19, further comprising refraining from transmitting a response to the third wireless AP in accordance with an engagement with another wireless device, in accordance with hidden transmissions from the third wireless AP, or both, wherein declining the second invitation is in accordance with refraining from transmitting the response.

Aspect 21: The method of aspect 20, further comprising receiving, from the third wireless AP at a start of a third transmission opportunity, a fourth frame that comprises a third invitation for the first wireless AP to perform a third CoBF sounding procedure with the third wireless AP.

Aspect 22: The method of any of aspects 16 through 21, wherein the at least first portion of the CoBF sounding procedure is performed in the first transmission opportunity and a second portion of the CoBF sounding procedure is performed in a second transmission opportunity, and wherein the first frame and the second frame are communicated at the start of the first transmission opportunity, the method further comprising: transmitting, to the second wireless AP at a start of the second transmission opportunity, a third frame comprising a second invitation to perform the second portion of the CoBF sounding procedure; and receiving, from the second wireless AP and in accordance with the third frame comprising the second invitation, a fourth frame indicating that the second wireless AP accepts the second invitation.

Aspect 23: The method of any of aspects 16 through 22, wherein the CoBF sounding procedure is performed in the first transmission opportunity.

Aspect 24: The method of any of aspects 16 through 23, wherein the first information indicates a quantity of transmission opportunities in which the CoBF sounding procedure is to be performed, or the second information indicates the quantity of transmission opportunities in which the CoBF sounding procedure is to be performed.

Aspect 25: The method of any of aspects 16 through 24, wherein the first information indicates a first quantity of spatial streams supported for reception of sounding packets by the one or more first wireless STAs, the second information indicates a second quantity of spatial streams supported for reception of the sounding packets by one or more second wireless STAs, and the CoBF sounding procedure is performed in accordance with one of the first quantity of spatial streams or the second quantity of spatial streams.

Aspect 26: The method of any of aspects 16 through 25, wherein the first information indicates a first quantity of LTFs supported for reception of sounding packets by the one or more first wireless STAs, the second information indicates a second quantity of LTFs supported for reception of the sounding packets by one or more second wireless STAs, and the CoBF sounding procedure is performed in accordance with one of the first quantity of LTFs or the second quantity of LTFs

Aspect 27: The method of any of aspects 16 through 26, wherein the first wireless AP is a synchronization follower for the CoBF sounding procedure in accordance with reception of the first frame from the first wireless AP, the method further comprising: receiving, from the first wireless AP, one or more synchronization signals; and synchronizing a time, a phase, a frequency, or any combination thereof, of one or more sounding packets according to the one or more synchronization signals.

Aspect 28: The method of any of aspects 16 through 27, wherein the first information indicates that one of the first wireless AP or the second wireless AP is a synchronization reference for the CoBF sounding procedure.

Aspect 29: The method of any of aspects 16 through 28, wherein the first information indicates whether to refrain from communicating a first initial control frame and a first initial control response frame with one or more second wireless STAs as part of the CoBF sounding procedure in accordance with a first mode in which the one or more second wireless STAs are operating, and the second information indicates whether to refrain from communicating a second initial control frame and a second initial control response frame to the one or more first wireless STAs as part of the CoBF sounding procedure in accordance with a second mode in which the one or more first wireless STAs are operating.

Aspect 30: The method of aspect 29, further comprising transmitting, to the one or more first wireless STAs, a management frame, a control frame, or both, that indicates to the one or more first wireless STAs to disable a first mode at the one or more first wireless STAs, wherein the second information indicates to refrain from communicating the second initial control frame and the second initial control response frame in accordance with the management frame, the control frame, or both.

Aspect 31: A first wireless AP for wireless communication, comprising one or more memories storing processor-executable code, and one or more processors coupled with the one or more memories and individually or collectively operable to execute the code to cause the first wireless AP to perform a method of any of aspects 1 through 15.

Aspect 32: A first wireless AP for wireless communication, comprising at least one means for performing a method of any of aspects 1 through 15.

Aspect 33: A non-transitory computer-readable medium storing code for wireless communication, the code comprising instructions executable by one or more processors to perform a method of any of aspects 1 through 15.

Aspect 34: A computer program comprising instructions that, when executed by one or more processors of a first wireless AP, cause the first wireless AP to perform the method of any of aspects 1 through 15.

Aspect 35: A first wireless AP for wireless communication, comprising one or more memories storing processor-executable code, and one or more processors coupled with the one or more memories and individually or collectively operable to execute the code to cause the first wireless AP to perform a method of any of aspects 16 through 30.

Aspect 36: A first wireless AP for wireless communication, comprising at least one means for performing a method of any of aspects 16 through 30.

Aspect 37: A non-transitory computer-readable medium storing code for wireless communication, the code comprising instructions executable by one or more processors to perform a method of any of aspects 16 through 30.

Aspect 38: A computer program comprising instructions that, when executed by one or more processors of a first wireless AP, cause the first wireless AP to perform the method of any of aspects 16 through 30.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
transmit, to a second wireless AP at a start of a first transmission opportunity, a first frame that comprises an invitation for the second wireless AP to perform a coordinated beamforming sounding procedure with the first wireless AP and comprises first information associated with the coordinated beamforming sounding procedure, one or more first wireless stations (STAs) being associated with the first wireless AP participating in the coordinated beamforming sounding procedure;
receive, from the second wireless AP and in accordance with the first frame comprising the invitation, a second frame that indicates whether the second wireless AP accepts the invitation to perform the coordinated beamforming sounding procedure with the first wireless AP, the second frame comprising second information associated with the coordinated beamforming sounding procedure; and
perform, in accordance with the second wireless AP accepting the invitation, at least a first portion of the coordinated beamforming sounding procedure with the second wireless AP in the first transmission opportunity, the coordinated beamforming sounding procedure being performed in accordance with the first information and the second information.

2. The first wireless AP of claim 1, wherein the processing system is further configured to cause the first wireless AP to:
transmit, to a third wireless AP at a start of a second transmission opportunity, a third frame that comprises a second invitation for the third wireless AP to perform a second coordinated beamforming sounding procedure with the first wireless AP; and
refrain from performing the second coordinated beamforming sounding procedure in accordance with the third wireless AP declining the second invitation.

3. The first wireless AP of claim 2, wherein the processing system is further configured to cause the first wireless AP to receive a fourth frame that indicates the third wireless AP declines the invitation, wherein refraining from performing the second coordinated beamforming sounding procedure is in accordance with the fourth frame.

4. The first wireless AP of claim 3, wherein the fourth frame indicates a reason for declining the invitation, and the reason comprises one or more of an indication that the third wireless AP is in agreement with one or more other wireless APs for coordinated beamforming, an indication that the third wireless AP has reached a threshold quantity of coordinated beamforming agreements supported by the third wireless AP, an indication that traffic associated with one or more third wireless STAs is insufficient for the coordinated beamforming sounding procedure, an indication that the one or more third wireless STAs have one or more operation modes enabled that are incompatible with the coordinated beamforming sounding procedure, an indication that the first wireless AP has failed to successfully receive channel state information from the one or more third wireless STAs, or an indication that the one or more third wireless STAs are not candidates for performing the coordinated beamforming sounding procedure.

5. The first wireless AP of claim 2, wherein refraining from performing the second coordinated beamforming sounding procedure is in accordance with a failure to receive a response from the third wireless AP.

6. The first wireless AP of claim 5, wherein the processing system is further configured to cause the first wireless AP to transmit, to the third wireless AP at a start of a third transmission opportunity, a fourth frame that comprises a third invitation for the third wireless AP to perform a third coordinated beamforming sounding procedure with the first wireless AP.

7. The first wireless AP of claim 1, wherein the at least first portion of the coordinated beamforming sounding procedure is performed in the first transmission opportunity and a second portion of the coordinated beamforming sounding procedure is performed in a second transmission opportunity, and the processing system is further configured to cause the first wireless AP to:
receive, from the second wireless AP at a start of the second transmission opportunity, a third frame comprising a second invitation to perform the second portion of the coordinated beamforming sounding procedure; and
transmit, to the second wireless AP and in accordance with the third frame comprising the second invitation, a fourth frame indicating that the first wireless AP accepts the second invitation.

8. The first wireless AP of claim 1, wherein the coordinated beamforming sounding procedure is performed in the first transmission opportunity.

9. The first wireless AP of claim 1, wherein the first information indicates a quantity of transmission opportunities in which the coordinated beamforming sounding procedure is to be performed, or the second information indicates the quantity of transmission opportunities in which the coordinated beamforming sounding procedure is to be performed.

10. The first wireless AP of claim 1, wherein:
the first information indicates a first quantity of spatial streams supported for reception of sounding packets by the one or more first wireless STAs,
the second information indicates a second quantity of spatial streams supported for reception of the sounding packets by one or more second wireless STAs, and
the coordinated beamforming sounding procedure is performed in accordance with one of the first quantity of spatial streams or the second quantity of spatial streams.

11. The first wireless AP of claim 1, wherein:
the first information indicates a first quantity of long-training fields supported for reception of sounding packets by the one or more first wireless STAs,
the second information indicates a second quantity of long-training fields supported for reception of the sounding packets by one or more second wireless STAs, and
the coordinated beamforming sounding procedure is performed in accordance with one of the first quantity of long-training fields or the second quantity of long-training fields.

12. The first wireless AP of claim 1, wherein the first wireless AP is a synchronization reference for the coordinated beamforming sounding procedure in accordance with transmission of the first frame to the second wireless AP, and the processing system is further configured to cause the first wireless AP to:
transmit, to the second wireless AP, one or more synchronization signals, wherein a timing, a phase, a frequency, or any combination thereof, of one or more sounding packets from the second wireless AP are in accordance with the one or more synchronization signals.

13. The first wireless AP of claim 1, wherein the first information indicates that one of the first wireless AP or the second wireless AP is a synchronization reference for the coordinated beamforming sounding procedure.

14. The first wireless AP of claim 1, wherein:
the first information indicates whether to refrain from communicating a first initial control frame and a first initial control response frame with the one or more first wireless STAs as part of the coordinated beamforming sounding procedure in accordance with a first mode in which the one or more first wireless STAs are operating, and
the second information indicates whether to refrain from communicating a second initial control frame and a second initial control response frame with one or more second wireless STAs as part of the coordinated beamforming sounding procedure in accordance with a second mode in which the one or more second wireless STAs are operating.

15. The first wireless AP of claim 14, wherein the processing system is further configured to cause the first wireless AP to transmit, to the one or more first wireless STAs, a management frame, a control frame, or both, that indicates to the one or more first wireless STAs to disable a first mode at the one or more first wireless STAs, wherein the first information indicates to refrain from communicating the first initial control frame and the first initial control response frame in accordance with the management frame, the control frame, or both.

16. A first wireless access point (AP), comprising:
a processing system that includes processor circuitry and memory circuitry that stores code, the processing system configured to cause the first wireless AP to:
receive, from a second wireless AP at a start of a first transmission opportunity, a first frame that comprises an invitation for the first wireless AP to perform a coordinated beamforming sounding procedure with the second wireless AP and comprises first information associated with the coordinated beamforming sounding procedure, one or more first wireless stations (STAs) being associated with the first wireless AP participating in the coordinated beamforming sounding procedure;
transmit, to the second wireless AP and in accordance with the first frame comprising the invitation, a second frame that indicates whether the first wireless AP accepts the invitation to perform the coordinated beamforming sounding procedure with the second wireless AP, the second frame comprising second information associated with the coordinated beamforming sounding procedure; and
perform, in accordance with the first wireless AP accepting the invitation, at least a first portion of the coordinated beamforming sounding procedure with the second wireless AP in the first transmission opportunity, the coordinated beamforming sounding procedure being performed in accordance with the first information and the second information.

17. The first wireless AP of claim 16, wherein the processing system is further configured to cause the first wireless AP to:
receive, from a third wireless AP at a start of a second transmission opportunity, a third frame that comprises a second invitation for the first wireless AP to perform a second coordinated beamforming sounding procedure with the third wireless AP; and
decline the second invitation to perform the second coordinated beamforming sounding procedure with the third wireless AP.

18. The first wireless AP of claim 17, wherein the processing system is further configured to cause the first wireless AP to transmit, to the third wireless AP, a fourth frame that indicates the first wireless AP declines the invitation.

19. The first wireless AP of claim 18, wherein the fourth frame indicates a reason for declining the invitation, and the reason comprises one or more of an indication that the first wireless AP is in agreement with one or more other wireless APs for coordinated beamforming, an indication that the first wireless AP has reached a threshold quantity of coordinated beamforming agreements supported by the first wireless AP, an indication that traffic associated with the one or more first wireless STAs is insufficient for the coordinated beamforming sounding procedure, an indication that the one or more first wireless STAs have one or more operation modes enabled that are incompatible with the coordinated beamforming sounding procedure, an indication that the third wireless AP has failed to successfully receive channel state information from the one or more first wireless STAs, or an indication that the one or more first wireless STAs are not candidates for performing the coordinated beamforming sounding procedure.

20. The first wireless AP of claim 17, wherein the processing system is further configured to cause the first wireless AP to refrain from transmitting a response to the third wireless AP in accordance with an engagement with another wireless device, in accordance with hidden transmissions from the third wireless AP, or both, wherein declining the second invitation is in accordance with refraining from transmitting the response.

21. The first wireless AP of claim 20, wherein the processing system is further configured to cause the first wireless AP to receive, from the third wireless AP at a start of a third transmission opportunity, a fourth frame that comprises a third invitation for the first wireless AP to perform a third coordinated beamforming sounding procedure with the third wireless AP.

22. The first wireless AP of claim 16, wherein the at least first portion of the coordinated beamforming sounding procedure is performed in the first transmission opportunity and a second portion of the coordinated beamforming sounding procedure is performed in a second transmission opportunity, and the processing system is further configured to cause the first wireless AP to:
transmit, to the second wireless AP at a start of the second transmission opportunity, a third frame comprising a second invitation to perform the second portion of the coordinated beamforming sounding procedure; and
receive, from the second wireless AP and in accordance with the third frame comprising the second invitation, a fourth frame indicating that the second wireless AP accepts the second invitation.

23. The first wireless AP of claim 16, wherein the coordinated beamforming sounding procedure is performed in the first transmission opportunity.

24. The first wireless AP of claim 16, wherein the first information indicates a quantity of transmission opportunities in which the coordinated beamforming sounding procedure is to be performed, or the second information indicates the quantity of transmission opportunities in which the coordinated beamforming sounding procedure is to be performed.

25. The first wireless AP of claim 16, wherein:
the first information indicates a first quantity of spatial streams supported for reception of sounding packets by the one or more first wireless STAs,
the second information indicates a second quantity of spatial streams supported for reception of the sounding packets by one or more second wireless STAs, and
the coordinated beamforming sounding procedure is performed in accordance with one of the first quantity of spatial streams or the second quantity of spatial streams.

26. The first wireless AP of claim 16, wherein:
the first information indicates a first quantity of long-training fields supported for reception of sounding packets by the one or more first wireless STAs,
the second information indicates a second quantity of long-training fields supported for reception of the sounding packets by one or more second wireless STAs, and
the coordinated beamforming sounding procedure is performed in accordance with one of the first quantity of long-training fields or the second quantity of long-training fields.

27. The first wireless AP of claim 16, wherein the first wireless AP is a synchronization follower for the coordinated beamforming sounding procedure in accordance with reception of the first frame from the first wireless AP, and the processing system is further configured to cause the first wireless AP to:
receive, from the first wireless AP, one or more synchronization signals; and
synchronize a time, a phase, a frequency, or any combination thereof, of one or more sounding packets according to the one or more synchronization signals.

28. The first wireless AP of claim 16, wherein the first information indicates that one of the first wireless AP or the second wireless AP is a synchronization reference for the coordinated beamforming sounding procedure.

29. A method for wireless communication by a first wireless access point (AP), comprising:
transmitting, to a second wireless AP at a start of a first transmission opportunity, a first frame that comprises an invitation for the second wireless AP to perform a coordinated beamforming sounding procedure with the first wireless AP and comprises first information associated with the coordinated beamforming sounding procedure, one or more first wireless stations (STAs) being associated with the first wireless AP participating in the coordinated beamforming sounding procedure;
receiving, from the second wireless AP and in accordance with the first frame comprising the invitation, a second frame that indicates whether the second wireless AP accepts the invitation to perform the coordinated beamforming sounding procedure with the first wireless AP, the second frame comprising second information associated with the coordinated beamforming sounding procedure; and
performing, in accordance with the second wireless AP accepting the invitation, at least a first portion of the coordinated beamforming sounding procedure with the second wireless AP in the first transmission opportunity, the coordinated beamforming sounding procedure being performed in accordance with the first information and the second information.

30. A method for wireless communication by a first wireless access point (AP), comprising:
receiving, from a second wireless AP at a start of a first transmission opportunity, a first frame that comprises an invitation for the first wireless AP to perform a coordinated beamforming sounding procedure with the second wireless AP and comprises first information associated with the coordinated beamforming sounding procedure, one or more first wireless stations (STAs) being associated with the first wireless AP participating in the coordinated beamforming sounding procedure;
transmitting, to the second wireless AP and in accordance with the first frame comprising the invitation, a second frame that indicates whether the first wireless AP accepts the invitation to perform the coordinated beamforming sounding procedure with the second wireless AP, the second frame comprising second information associated with the coordinated beamforming sounding procedure; and
performing, in accordance with the first wireless AP accepting the invitation, at least a first portion of the coordinated beamforming sounding procedure with the second wireless AP in the first transmission opportunity, the coordinated beamforming sounding procedure being performed in accordance with the first information and the second information.
